(19) United States
(12) Patent Application Publication
(10) Pub. No.: US 2001/0019390 A1
(43) Pub. Date: Sep. 6, 2001

(54) Liquid crystal display apparatus

(76) Inventors: Nobuyuki Itoh, Chiba (JP); Akira Tagawa, Chiba (JP); Masaaki Kabe, Chiba (JP); Tomoo Furukawa, Nara (JP)

Correspondence Address: Dike, Bronstein, Roberts & Cushman, Intellectual Property Practice Group, EDWARDS & ANGELL, P.O. Box 9169, Boston, MA, 02109, US

(21) Appl. No.: 09/745,074

(22) Filed: Dec. 20, 2000

(30) Foreign Application Priority Data
Dec. 20, 1999 (JP) 11-361949
Feb. 24, 2000 (JP) 2000-046981

(51) Int. Cl. G02F 1/1337

(52) U.S. Cl. 349/130; 349/141

(57) ABSTRACT

A liquid crystal display apparatus includes: a pair of substrates opposing each other; a liquid crystal layer interposed between the pair of substrates, the liquid crystal layer containing liquid crystal molecules having a negative dielectric anisotropy; at least one electrode provided on each of the pair of substrates, the at least one electrode being used for applying an electric field across the liquid crystal layer; and at least one volume excluding member. One of the at least one volume excluding member is provided on the at least one electrode on at least one of the pair of substrates, the volume excluding member being provided so as to be on at least a portion of one side edge of the at least one electrode. A side of each of the pair of substrates facing the liquid crystal layer is subjected to a vertical alignment treatment. The liquid crystal molecules are tilted in a uniform direction from the at least one side edge of the at least one electrode to an opposite edge when a voltage is applied to the at least one electrode.

### BACKGROUND OF THE INVENTION

1. Field of the Invention

The present invention relates to a liquid crystal (Lc) display apparatus of a so-called VA (vertical aligned) mode, in which optical changes take place responsive to the application of an electric field for causing LC molecules which were originally oriented in a vertical alignment to be realigned in a horizontal alignment. In particular, the present invention relates to a high-contrast and fast-response LC display apparatus which ensures that LC molecules will tilt in asymmetrical directions, unlike in conventional liquid crystal display apparatuses in which LC molecules are controlled so as to tilt in symmetrical directions to control discontinuities in LC orientation (disclination). Moreover, the present invention relates to a high-contrast and fast-response LC display apparatus in which a tilt direction of LC molecules is controlled so as to be in one direction in portions of the display corresponding to pixels, whereas the LC molecules in any portions other than the pixels are placed in a horizontal alignment realized through a uniaxial alignment treatment, whereby a gradually changing LC orientation can be obtained at boundaries between pixel portions and non-pixel portions, while preventing disclination.

2. Description of the Related Art

FIG. 15 is a cross-sectional view illustrating the structure of a conventional LC display apparatus 1500. The LC display apparatus 1500 is produced by using a pair of substrates 1501 and 1502, which are attached together with electrodes 1503 and 1504 provided on the respective faces of the substrates 1501 and 1502, opposing each other. The substrates 1501 and 1502 may be glass substrates. The electrodes 1503 and 1504 may be formed of ITO (indium tin oxide). As necessary, insulation films 1507 and 1508, and alignment films 1509 and 1510 are provided on the electrodes 1503 and 1504, respectively. The alignment films 1509 and 1510 are subjected to an alignment treatment such as a rubbing treatment, as necessary, Spacers 1511 having a desired diameter are provided between the substrates 1501 and 1502 so as to secure a uniform interspace therebetween. The substrates 1501 and 1502 are attached and fixed together with a sealant 1512. Finally, liquid crystal (LC) 1513 is injected through an aperture opened in the sealant 1512, after which the injection aperture is sealed, thus completing the LC display apparatus 1500.

The alignment treatment applied to the alignment films 1509 and 1510 places molecules of the LC 1513 in a uniform alignment. The electrodes 1503 and 1504 have external lead portions, via which an arbitrary signal waveform field can be applied to the LC 1513. The LC molecules change their orientation in accordance with the applied field so as to polarize and modulate light which passes through the LC layer. The LC display apparatus 1500 can perform a displaying function with, as necessary, a polarizer for rendering the polarization and modulation of light visible to eyesight. In order to allow light to pass through the LC layer, at least one of the electrodes 1503 and 1504 must be a transparent electrode, which may be formed of ITO or the like.

FIGS. 16 and 17 illustrate LC display apparatuses having two different types of electrode structures: a simple matrix type LC display apparatus 1600; and an active matrix type LC display apparatus 1700, respectively. For clarity of illustration, only the substrates and the electrodes are shown in each of these figures. In the simple matrix type LC display apparatus 1600 shown in FIG. 16, substrates 1601 and 1602 are disposed in such directions that stripe-shape electrodes 1603 and 1604 (which are respectively provided on the substrates 1601 and 1602) intersect one other. In the active matrix type LC display apparatus 1700 shown in FIG. 17, intersecting signal electrodes 1705 and switching elements (e.g., transistors) 1706 are provided on a substrate 1701. Currently, nematic LC is most frequently used as an LC material in both of these types of LC display apparatuses.

Owing to its simple structure, a simple matrix type LC display apparatus is relatively easy to produce. However, since a simple matrix type LC display apparatus lacks switching elements dedicated for respective pixels, all the pixels are coupled via the capacitance of the LC. Thus, a simple matrix type LC display apparatus is inherently associated with the problem of so-called crosstalk; i.e., the threshold values for respective pixels become less defined as the pixels increase in number, resulting in unclear displayed images. In addition, an ITO or nesa film used as a transparent electrode has a resistance value which is about 100 to 1000 times higher than those of metals, although generally conductive. Thus, as the display apparatus becomes larger in size and information capacity, the problem of distorted signal waveforms due to the resistance of the transparent electrodes (“electrode resistance”) become more pronounced.

Accordingly, attempts have been made to reduce the electrode resistance by providing transparent electrodes and metal wiring in a parallel arrangement. However, such attempts have led to decreased luminance due to a reduced aperture ratio, and/or less facility of production, thereby detracting from the advantages associated with a simple matrix type LC display apparatus.

On the other hand, an active matrix type LC display apparatus features a switching element for each pixel. Therefore, although an active matrix type Lc display apparatus may not be as easy to produce as a simple matrix type LC display apparatus, the problem of crosstalk is substantially eliminated because each pixel can be independently driven, thereby making for much clearer displayed images than those provided by a simple matrix type LC display apparatus. Moreover, the problem of distorted signal waveforms due to electrode resistance is almost negligible in an active matrix type LC display apparatus because signal lines which do not contribute to light transmission can be formed of a metal such as Ti or Al, and an opposing transparent electrode may be in the form of an unpatterned bulk shest. Thus, an active matrix type LC display apparatus can be relatively easily produced in a large size with a large information capacity.

An attempt to solve the problem of crosstalk has been made by using ferroelectric LC for a simple matrix type LC display apparatus, and making use of the relatively simple structure of a simple matrix type LC display apparatus [N. Itoh et al., Proceedings of The Fifth International Display Workshops (IDW'98)(1998) p. 205 “17 Video-Rate Full Color FLCD”]. Since ferroelectric LC has memory properties and a quick response on the order of microseconds [N. Clark et al., Apply. Phys. Lett., 36(1980), p. 899 “Submicrosecond bistable electro-optic switching in liquid crystals”], it is possible to adopt a different line sequential driving method from that adopted in conventional simple matrix modes utilizing nematic LC, which does not have memory properties. Specifically, the line sequential driving method adapted for a ferroelectric simple matrix type LC display apparatus involves sequentially writing display information in each scanning line with a high speed, and retaining the display information thus written until an “overwrite” signal is input. As a result, it is possible to display as clear an image as that provided by an active matrix type LC display apparatus, while preventing crosstalk.

However, the problem associated with electrode resistance cannot be solved even by using ferroelectric LC in a simple matrix type LC display apparatus. The problem of distorted signal waveforms which is induced by electrode resistance is not only an obstacle to realizing a large display apparatus with a large information capacity, but is also detrimental to realizing a “fast” signal waveform. Especially in applications utilizing ferroelectric LC having a fast response, the aforementioned technique of providing transparent electrodes and metal wiring in a parallel arrangement is essential; however, this leads to decreased luminance due to a reduced aperture ratio, and/or less facility of production, thereby detracting from the advantages associated with a simple matrix type LC display apparatus. In addition, electrode resistance also increases power consumption and induces heating of the LC panel.

From the above perspective, the active matrix mode (except for that used in some lower-performance display apparatuses) is advantageous for display apparatuses which are intended to display moving images with a high resolution. Among others, a TFT (thin film transistor) mode is superior to a MIM (metal-insulator-metal) mode or other modes because a TFT has three terminals whereas a MIM element has two terminals. A large number of practical applications are based on the TFT mode.

Currently, a 20″ liquid crystal TV which combines the TFT mode with nematic LC has been realized. It may even appear that the field of flat display apparatuses has come to full development with the current TFT-nematic LC technique, while only leaving larger size and large information capacity to be pursued.

However, LC display apparatuses are still plagued with some critical problems concerning display quality, and these problems must be solved before LC display apparatuses can rival and eventually replace CRTs (cathode ray tubes), which represent the mainstream in the field of display apparatuses. While CRTs have their own problems of bulkiness and heaviness, liquid crystal has a critical problem of slow response to signal waveform fields, among other problems. Hereinafter, the relationship between response speed and display quality of LC will be discussed.

Blurring artifacts are perceived when moving images are displayed by current TFT-nematic LC display apparatuses (hereinafter simply referred to as “LCDs”), which presents a major problem. The mechanism which creates such blurring artifacts in LCDs is fully described in [Kurita, 1998 LCD forum: “How can LCDS make their way into the CRT monitor market—from the perspective of moving image display—”, p. 1 “Display modes of hold type displays and display quality when displaying moving images”].

FIGS. 18A and 18B are graphs for illustrating a difference in time response of display light between CRTs and LCDs, in which the horizontal axis represents time and the vertical axis represents luminance. FIG. 18A is a graph illustrating impulse type display light of a CRT. FIG. 18B is a graph illustrating hold type display light of an LCD. The display light of an LCD is said to be of a “hold type” because LC does not spontaneously emit light, but rather functions as a shutter for selectively transmitting or intercepting light from a backlight device. TN (twisted nematic) liquid crystal, which is widely known and used at present, has a response speed of about 15 ms. Therefore, it will be seen that TN liquid crystal takes almost the entirety of one field, i.e., 16.7 ms, to respond. Herein, a decrease in response time is tantamount to an increase in response speed.

With a hold type display as described above, in the presence of a perfect pursued eye movement (i.e., a concurrent movement of right and left eyes to substantially similarly follow a moving object in a smooth manner), which plays the most important role in moving image perception among other types of eyeball movements, and in the presence of a full time quadrature or integration effect in eyesight, then only an average brightness of a number of pixels will be perceived by a viewer, so that image fractions that are expressed in different pixels may be completely lost.

The pursued eye movement accounts for a smaller portion of eyeball movements as the speed of movement increases. However, it is assumed that any movement which is within about 4 to 5 degrees/second can be sufficiently followed by pursued eye movement alone. The maximum followable speed over a short period of time is supposed to be about 30 degrees/second. As for the time quadrature effect, it is assumed that optical stimuli occurring over a short period of time on the order of tens of milliseconds or less can be substantially completely integrated, even under a limited luminance. Since many of the actually displayed moving images are within such angular velocity constraints and luminance constraints, a hold type display mode may present blurred moving images which are associated with “eye tracking”.

Therefore, in order to eradicate blurring of moving images in an LCD, it is necessary to perform an impulse type display function as in the case of a CRT. This can be achieved either by using a shutter to feign impulse emission, or causing the backlight to quickly flash, rather than keeping the backlight on constantly as is currently practiced. In either case, it is necessary to substantially improve the response speed of LC from the present levels.

The above problem will be described with reference to the graphs of FIGS. 19A and 19B.

The vertical axis of FIG. 19A represents the amount of light transmitted by an LCD, and the horizontal axis represents time. The vertical axis of FIG. 19B represents the amount of light emitted by the backlight, and the horizontal axis represents time. In the graph of FIG. 19A, t represents an amount of time which is required for opening a gate (gate ON time) of a TFT, which is coupled to a scanning line; and n represents the number of scanning lines (gate lines). Thus, assuming that n scanning lines are included in the display apparatus, an amount of time t×n is required for turning on all of the TFTs. Therefore, there is a time gap of t×n between the rising curve of an amount of light transmitted through the LC corresponding to a first scanning line and the rising curve of an amount of light transmitted through the LC corresponding to an n^{th} scanning line. Herein, the two curves illustrated in the graph of FIG. 19A respectively represent a response-over-time profile of LC corresponding to the first scanning line and that corresponding to the n^{th} scanning line: τr represents the rising response time of LC; T represents the remainder of the duration of one field, i.e., 16.7 ms.

By activating the backlight (or causing the backlight to emit light) after an LC portion corresponding to the n^{th} line has responded after the turning on of the last gate line, i.e., n^{th} gate line, as shown in FIG. 19B, it is possible to attain an impulse type display function similar to that obtained with a CRT.

According to [Kurita, 1998 LCD forum: “How can LCDs make their way into the CRT monitor market—from the perspective of moving image display—”, p. 1 “Display modes of hold type displays and display quality when displaying moving images”], a light emission period ratio (compaction ratio) for a backlight which would be effective to attain an impulse type display function is about 25% of the duration of one field, i.e., 16.7 ms. From this, it follows that T must be about 4 ms. Now, n can be considered to be around 1000 in the context of high-vision broadcasting utilizing 1025 scanning lines. Then, the LC response time τr must be equal to or less than 16.7 ms−t×n−T.

Currently, the gate ON time t of a TFT is about 10 μs for amorphous silicon (αSi)-TFTs, with which a large (20″) liquid crystal display device has already been realized, and about 3 μs for dolysilicon (PSi)-TFTs, which is not suitable for implementation in a large size display but has a high electron mobility. Thus, it can be seen that an LC response time which is required for realizing full-specification moving images free from blurring artifacts will be about 2.5 ms or less for a Si-TFTs and about 9.7 ms or less for PSi-TFTs, if it is at all possible to employ PSi-TFTs. The high processing temperature of about 1000° C. or more that is required to produce PSi-TFTs makes it difficult to employ usual glass substrates; instead, quartz glass substrates must be used. This presents an obstacle to producing a large size display apparatus, and there is little feasibility for producing a display apparatus which can realize full-specification high-vision broadcast.

FIGS. 20A and 20B are graphs illustrating a manner in which, in a different field, LC is brought back to its original state to intercept light from being transmitted. In FIG. 20A, τd represents the falling response time of LC. Similarly to the rising response time τr, the falling response is also required to occur quickly. Moreover, the response time for displaying intermediate gray tones is generally about three times longer than the aforementioned rising response time τr or falling response time τd. Since the response speed for displaying intermediate gray tones is critical during actual display, it is essential to realize quick response speeds in general.

The response time of well-known TN liquid crystal is about 15 ms, as mentioned earlier with reference to rising response. Even if an impulse type backlight system is adopted, it would be difficult to realize full-specification moving images without blurring artifacts by using αSi-TFTs with a response time 2.5 ms or less. The falling response is even slower, and could take tens of milliseconds.

Thus, there has been plenty of work undertaken to solve the problems associated with response speed of TN liquid crystal. For example, research on using a bend cell or a pi cell to attain fast response is well known [Miyashita et al., 1998 LCD forum: “How can LCDs make their way into the CRT monitor market—from the perspective of moving image display—”, p. 7 “A field sequential full-color liquid crystal display utilizing quick response characteristics of OCB liquid crystal”]. It has been reported that the response time of a bend orientation cell is reduced to about 2 ms from the 15-ms response time of a conventional TN orientation cell. This enhanced response is realized by controlling the flow of LC within the cell that occurs during the response action of the LC. This flow is very substantial in a twisted orientation state, such as the TN orientation, presenting a major cause for slow response speed. Thus, any mode which is free from twisting during switching may make for a faster response speed as in the case of a bend cell.

A bend call, which is effective for realizing a fast response is critically disadvantageous for displaying high-quality TV images, in that a bend cell is used in combination with a phase difference plate method, i.e., a phase difference plate is required for optical compensation in order to obtain a practical level of contrast, as described in [Miyashita at al., 1998 LCD forum: “How can LCDs make their way into the CRT monitor market—from the perspective of moving image display—”p. 7 “A field sequential full-color liquid crystal display utilizing quick response characteristics of OCB liquid crystal”].

The phase difference plate method, which comes into play when a mere combination of an LC cell and polarization plates cannot provide a dark display state, utilizes a phase difference plate having a similar level of phase difference to a residual phase difference of an LC cell to eliminate the phase difference, thereby attaining a dark display state. Even with this method, which in theory would attain a perfect dark display state and a relatively high contrast, it is very difficult to attain a high contrast level over 200:1 in practice. The main reason is the difficulty in producing a phase difference plate in a uniform manner while matching the wavelength dependency of the phase differences (so-called wavelength dispersion) of an LC cell and a phase difference plate.

In general, the phase difference of a phase difference plate as an industrial product, which by definition is defined at the maximum luminosity wavelength, i.e., 550 nm, will have some wavelength dispersion in practice. On the part of the LC cell as well, residual phase difference will have some wavelength dispersion due to the wavelength dispersion associated with the birefringent property of LC. If the LC cell and the phase difference can be perfectly matched in terms of wavelength dispersion of phase difference, then the phase difference in the entire visible spectrum will be eliminated, thereby resulting in an excellent dark display state and high contrast. However, since such wavelength dispersion is associated with the birefringence of LC materials and materials for producing phase difference plates, in practice, it is very difficult to solve this problem insofar as quite different materials are used for the LC and the phase difference plate.

Furthermore, it is difficult to produce a phase difference plate having a perfectly uniform phase difference over a large area. In fact, a phase difference variation (local) of ±5 nm in a central portion, and a phase difference variation (global) of ±5 nm in an area of about 10″, would be inevitable in practice. For such reasons, the phase difference plate method is presumably not suitable for the purpose of displaying high-quality TV images.

### SUMMARY OF THE INVENTION

A liquid crystal display apparatus according to the present invention includes: a pair of substrates opposing each other; a liquid crystal layer interposed between the pair of substrates, the liquid crystal layer containing liquid crystal molecules having a negative dielectric anisotropy; at least one electrode provided on each of the pair of substrates, the at least one electrode being used for applying an electric field across the liquid crystal layer, and at least one volume excluding member, wherein: one of the at least one volume excluding member is provided on the at least one electrode on at least one of the pair of substrates, the volume excluding member being provided so as to be on at least a portion of one side edge of the at least one electrode; a side of each of the pair of substrates facing the liquid crystal layer is subjected to a vertical alignment treatment; and the liquid crystal molecules are tilted in a uniform direction from the at least one side edge of the at least one electrode to an opposite edge when a voltage is applied to the at least one electrode.

In one embodiment of the invention, the volume excluding member comprises at least one of a protrusion and a concave stepped portion.

In another embodiment of the invention, the volume excluding member is provided along the entirety of the at least one side edge of the at least one electrode.

Alternatively, a liquid crystal display apparatus according to the present invention includes: a pair of substrates opposing each other; a liquid crystal layer interposed between the pair of substrates, the liquid crystal layer containing liquid crystal molecules having a negative dielectric anisotropy; at least one electrode provided on each of the pair of substrates, the at least one electrode being used for applying an electric field across the liquid crystal layer; and a plurality of volume excluding members provided on the at least one electrode on at least one of the pair of substrates, each of the plurality of volume excluding members being provided so as to be on at least a portion of each of an opposing pair of side edges of the at least one electrode but so as not to oppose each other, wherein: a side of each of the pair of substrates facing the liquid crystal layer is subjected to a vertical alignment treatment; and the liquid crystal molecules are tilted in a uniform direction from the at least one side edge of the at least one electrode to an opposite edge when a voltage is applied to the at least one electrode.

In one embodiment of the invention, the at least one electrode on the at least one of the pair of substrates includes a first side edge and a second side edge; and the plurality of volume excluding members are provided along a portion of the first side edge and along a portion of the second side edge.

In another embodiment of the invention, a non-conductive window portion is formed in the at least one electrode on the at least one of the pair of substrates.

Alternatively, a liquid crystal display apparatus according to the present invention includes: a pair of substrates opposing each other; a liquid crystal layer interposed between the pair of substrates, the liquid crystal layer containing liquid crystal molecules; and at least one electrode provided on at least one of the pair of substrates, the at least one electrode being used for applying an electric field across the liquid crystal layer, wherein: the liquid crystal layer includes at least one pixel portion and a non-pixel portion, the at least one pixel portion corresponding to the at least one electrode; and when voltage is not applied to the at least one electrode, the liquid crystal molecules in the at least one pixel portion are oriented in a vertical alignment and the liquid crystal molecules in the non-pixel portion are oriented in a uniaxial horizontal alignment.

In one embodiment of the invention, the liquid crystal molecules in the at least one pixel portion are oriented in a horizontal alignment so as to be tilted in a uniform direction when a voltage is applied to the at least one electrode.

In another embodiment of the invention, a volume excluding member is formed on a portion of the at least one electrode.

In still another embodiment of the invention, the volume excluding member comprises at least one of a protrusion and a concave stepped portion.

In still another embodiment of the invention, a side of the at least one of the pair of substrates facing the liquid crystal layer is subjected to a rubbing treatment.

In still another embodiment of the invention, the at least one electrode comprises a comb electrode.

In still another embodiment of the invention, the liquid crystal molecules in the non-pixel portion are oriented in a uniaxial horizontal alignment by at least one method selected from the, group consisting of: subjecting a horizontal alignment film to a rubbing treatment; subjecting a vertical alignment film to a selective chemical modification treatment followed by a rubbing treatment; subjecting a vertical alignment film to a selective irradiation of ultraviolet rays followed by a rubbing treatment; and subjecting a vertical alignment film to an irradiation of selectively polarized ultraviolet rays.

In still another embodiment of the invention, a direction of the horizontal alignment of the liquid crystal molecules in the at least one pixel portion is substantially identical to a direction of uniaxial horizontal alignment of the liquid crystal molecules in the non-pixel portion.

Hereinafter, the effects of the present invention will be described.

According to one embodiment of the present invention, in a VA mode in which application of an electric field causes an LC material which is originally oriented in a vertical alignment to be realigned in a horizontal alignment, where the LC material has a negative dielectric an isotropy, a protrusion or a concave stepped portion is provided on a side of at least one substrate facing an LC layer, so as to be along a side edge of each pixel region. As a result, when an electric field is applied, LC molecules are tilted in a uniform direction from that edge to an opposite edge so as to take a horizontal alignment. Thus, high contrast and fast response can be achieved without allowing disclination to occur. Such protrusions or concave stepped portions may be provided on both substrates.

According to another embodiment of the present invention, in a VA mode, protrusions or concave stepped portions are provided on a side of at least one substrate facing the LC layer, so as to be along two opposite side edges of each pixel region without opposing each other. As a result, when an electric field is applied, LC molecules are tilted in a uniform direction from one edge to an opposite edge so as to take a horizontal alignment. Thus, high contrast and fast response can be achieved without allowing disclination to occur. Such protrusions or concave stepped portions may be provided on both substrates.

According to still another embodiment of the present invention, in a VA mode, protrusions or concave stepped portions are provided on a side of at least one substrate facing the LC layer, so as to be along a side edge of each subpixel region that is partitioned by a window portion. As a result, when an electric field is applied, LC molecules are tilted in a uniform direction from that edge to an opposite edge so as to take a horizontal alignment. Thus, high contrast and fast response can be achieved without allowing disclination to occur. Such protrusions or concave stepped portions may be provided on both substrates. Alternatively, such protrusions or concave stepped portions may be provided on one substrate, while window portions may be provided on the other substrate.

Thus, the invention described herein makes possible the advantages of providing a liquid crystal display apparatus which can provide high contrast and fast response and which can reproduce high-quality images free from blurring artifacts associated with moving images.

These and other advantages of the present invention will become apparent to those skilled in the art upon reading and understanding the following detailed description with reference to the accompanying figures.

### BRIEF DESCRIPTION OF THE DRAWINGS

FIG. 1A is a cross-sectional view illustrating an LC display apparatus according to Example 1 of the present invention in the absence of an applied electric field.

FIG. 1B is a cross-sectional view illustrating an LC display apparatus according to Example 1 of the present invention under an applied electric field.

FIG. 2A is a cross-sectional view illustrating an LC display apparatus according to Example 3 of the present invention in the absence of an applied electric field.

FIG. 2B is a cross-sectional view illustrating an LC display apparatus according to Example 3 of the present invention under an applied electric field.

FIG. 3A is a plan view for illustrating viewing angle characteristics of an LC display apparatus according to an example of the present invention under an applied electric field.

FIG. 3B is a cross-sectional view for illustrating viewing angle characteristics of an LC display apparatus according to an example of the present invention under an applied electric field.

FIG. 4A is a plan view illustrating an LC display apparatus according to Example 4 of the present invention.

FIG. 4B is a cross-sectional view illustrating an LC display apparatus according to Example 4 of the present invention under an applied electric field.

FIG. 5 is a plan view illustrating an LC display apparatus according to Example 5 of the present invention.

FIG. 6 is a plan view illustrating a variant of an LC display apparatus according to Example 5 of the present invention.

FIG. 7A is a cross-sectional view illustrating an LC display apparatus according to Example 2 of the present invention in the absence of an applied electric field.

FIG. 7B is a cross-sectional view illustrating an LC display apparatus according to Example 2 of the present invention under an applied electric field.

FIG. 8A is a cross-sectional view illustrating an LC display apparatus according to an example of the present invention in the absence of an applied electric field.

FIG. 8B is a cross-sectional view illustrating an LC display apparatus according to an example of the present invention under an applied electric field.

FIG. 9 is a plan view illustrating an LC display apparatus according to an example of the present invention under an applied electric field.

FIG. 10A is a cross-sectional view illustrating an LC display apparatus according to an example of the present invention in the absence of an applied electric field.

FIG. 10B is a cross-sectional view illustrating an LC display apparatus according to an example of the present invention under an applied electric field.

FIG. 11A is a cross-sectional view illustrating an LC display apparatus according to an example of the present invention in the absence of an applied electric field,

FIG. 11B across-sectional view illustrating an LC display apparatus according to an example of the present invention under an applied electric field.

FIG. 12A is a cross-sectional view illustrating an LC display apparatus according to an example of the present invention in the absence of an applied electric field.

FIG. 12B is across-sectional view illustrating an LC display apparatus according to an example of the present invention under an applied electric field.

FIG. 13A is a cross-sectional view illustrating an LC display apparatus according to an example of the present invention in the absence of an applied electric field.

FIG. 13B is a cross-sectional view illustrating an LC display apparatus according to an example of the present invention under an applied electric field.

FIG. 14A is a cross-sectional view illustrating an LC display apparatus according to an example of the present invention in the absence of an applied electric field.

FIG. 14B is a cross-sectional view illustrating an LC display apparatus according to an example of the present invention under an applied electric field.

FIG. 15 is a cross-sectional view illustrating an LC display apparatus.

FIG. 16 is a perspective view illustrating a simple matrix type LC display apparatus.

FIG. 17 is a perspective view illustrating an active matrix type LC display apparatus.

FIG. 18A is a graph illustrating impulse type display light provided by a CRT.

FIG. 18B is a graph illustrating hold type display light provided by an LCD .

FIG. 19A is a graph illustrating a transmitted light amount profile of an LCD in the case of performing an impulse type display function.

FIG. 19B is a graph illustrating an emission light amount profile of a backlight, associated with a rising response of an LCD, in the case of performing an impulse type display.

FIG. 20A is a graph illustrating a transmitted light amount profile of an LCD in the case of performing an impulse type display function.

FIG. 20B is a graph illustrating an emission light amount profile of a backlight, associated with a falling response of an LCD, in the case of performing an impulse type display.

FIG. 21A is across-sectional view illustrating a conventional VA mode LC display apparatus in the absence of an applied electric field.

FIG. 21B is a cross-sectional view illustrating a conventional VA mode LC display apparatus under an applied electric field.

FIG. 22A is a cross-sectional view illustrating a VA mode LC display apparatus in the absence of an applied electric field.

FIG. 22B is a cross-sectional view illustrating a VA mode LC display apparatus under an applied electric field.

FIG. 23A is a cross-sectional view illustrating a VA mode LC display apparatus in the absence of an applied electric field.

FIG. 23B is across-sectional view illustrating a VA mode LC display apparatus under an applied electric field.

FIG. 24A is a cross-sectional view illustrating a VA mode LC display apparatus in the absence of an applied electric field.

FIG. 24B is a cross-sectional view illustrating a VA mode LC display apparatus under an applied electric field.

FIG. 25 is a plan view illustrating a conventional LC display apparatus.

### DESCRIPTION OF THE PREFERRED EMBODIMENTS

As discussed earlier, any mode which is free from twisting during switching could make for a fast response speed. A VA mode is known as a mode which does not require any phase difference plates but which only requires polarization plates to attain an excellent dark state and high contrast without causing twisting. According to a VA mode, an LC material having a negative dielectric anisotropy AE, which is originally oriented in a vertical alignment, may be realigned in a horizontal alignment responsive to an electric field applied between the substrates. Alternatively, an LC material having a positive dielectric anisotropy AE, which is originally oriented in a vertical alignment, may be realigned in a horizontal alignment responsive to an electric field applied in a direction parallel to the substrate surfaces;

According to a VA mode, birefringence is substantially completely eliminated because the LC material takes a vertical alignment in an initial state. Thus, an excellent dark display state, similar to that obtained through a pair of cross-nicol polarization plates alone, can be easily attained, thereby providing for high contrast display. A report has been made on the achievement of a very high contrast of 700:1 or above [H. D. Liu et al., Euro Display 99 Late news papers, (1999) p. 31 “A Wide Viewing Angle Back Side Exposure MVA TFT LCD with Novel Structure and Simple Process”].

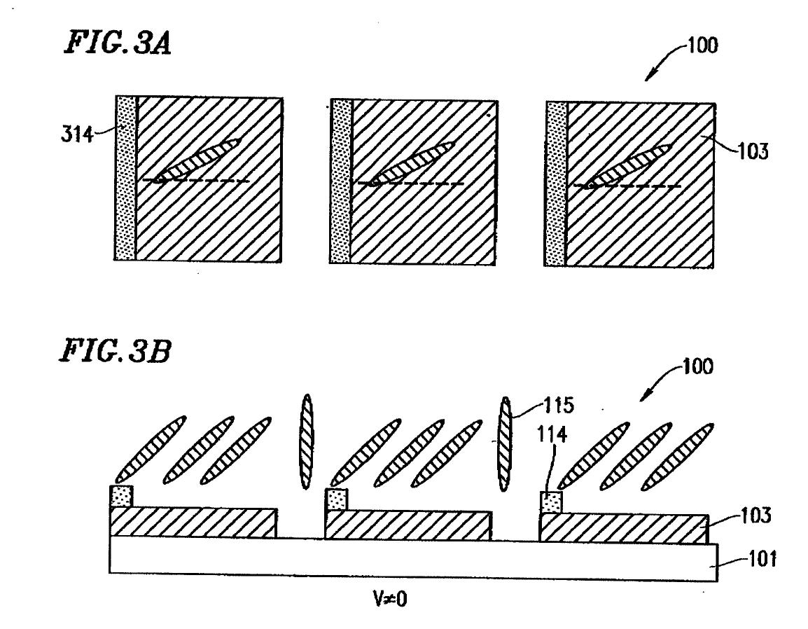

The VA mode, which is highly advantageous in terms of contrast, is susceptible to disclination, As illustrated in FIG. 3 of C. K. Wei et al., SID 98 DIGEST (1998) p. 1081 “A Wide Viewing Angle Polymer Stabilized Homeotropic Aligned LCD”, disclination can be explained as a phenomenon in which random discontinuities in orientation (i.e., “disclination”) arise in response to an applied electric field causing LC molecules to be tilted in an omnidirectional manner. Disclination, which may typically occur in a structure in which an LC material is merely pre-oriented in a vertical alignment between a pair of opposing substrates placed in a parallel arrangement, can hinder uniform display.

There has been plenty of research performed on the problem of disclination, As described in the above publication, the technique of controlling the tilting direction of LC molecules by means of protrusions formed on substrates has been established. Other than forming protrusions, a method is known from Japanese Laid-Open Patent Publication No. 7-199190 involving forming an opening in each pixel electrode and providing another electrode around the pixel electrode for orientation controlling purposes, whereby disclinatton can be controlled,

Thus, there are known techniques for solving display nniformity problems associated with the VA mode. However, known VA mode structures are still slower in terms of response speed than band cell-based structures (see above), and may even be as slow as conventional TN mode structures. In fact, the slow response speed of the VA mode is also ascribable to disclination. A report has been made which describes an experiment directed to various shapes of disclination (Table 1), indicating that cells having disclination controlled to be in a one-dimensional shape exhibit much faster response speed than cells having disclination controlled to be in a two-dimensional shape as described in the above publication [K. Ohmuro et al., SID 97 DIGEST (1997) p. 845 “Development of Super High Image Quality Vertical Alignment Mode LCD”, disclination].

According to K. Ohmuro et al., SID 97 DIGEST (1997) p. 845 “Development of Super High Image Quality Vertical Alignment Mode LCD”, supra, a rising response time of 8 ms and a falling response time of 5 ms have been realized with ohe-dimensional disolination.

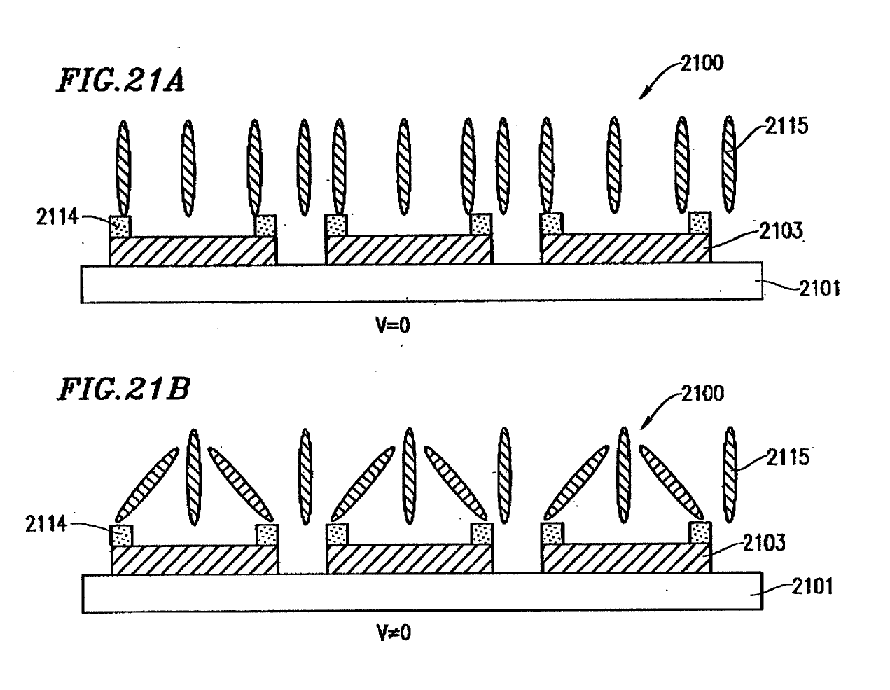

Now, referring to FIGS. 21A and 21B disclination occurring in the VA mode will be described. FIG. 21A is a cross-sectional view illustrating a conventional VA mode LC display apparatus 2100 in the absence of an applied electric field. FIG. 21B is a cross-sectional view illustrating the conventional VA mode LC display apparatus 2100 under an applied electric field. A counter substrate, electrodes, alignment films, and like elements are omitted from illustration in FIGS. 21A and 21B. In the LC display apparatus 2100, protrusions 2114 are provided along opposite side edges of electrodes 2103. As a result, under an applied voltage, disclination occurs above a central region of each pixel electrode 2103 and above non-pixel portions.

The detailed mechanism of how disclination affects response speed is not clear. However, one presumable reason is that, as shown in FIGS. 21A and 21B. LC molecules in any disclinated portions collide with LC molecules on both sides, whereby the movement of the LC in hindered. Therefore, it is presumable that the response speed decreases when there is more disclination, and that the response speed increases when there is less disclination.

In order to attain further enhancement of response speed, it is necessary to realize a switching mode which is free from disclination. Accordingly, Japanese Laid-Open Patent Publication No. 11-44885 discloses a method which involves orienting LC molecules with a pretilt angle of several degrees from a completely vertical alignment, which may be implemented by, for example, providing slanted portions in a substrate as described in Japanese Laid-Open Patent Publication No. 2-190825, or subjecting a vertical alignment film to a rubbing treatment as described in Japanese Patent No. 2907228. However, these methods detract from an excellent dark display state which would otherwise be attained by a vertical alignment.

Therefore, according to the present invention, there is provided a mode of switching which retains a substantially perfect vertical alignment in an initial state and which can prevent disclination, in order to make full use of the high contrast and fast response potentials of the VA mode.

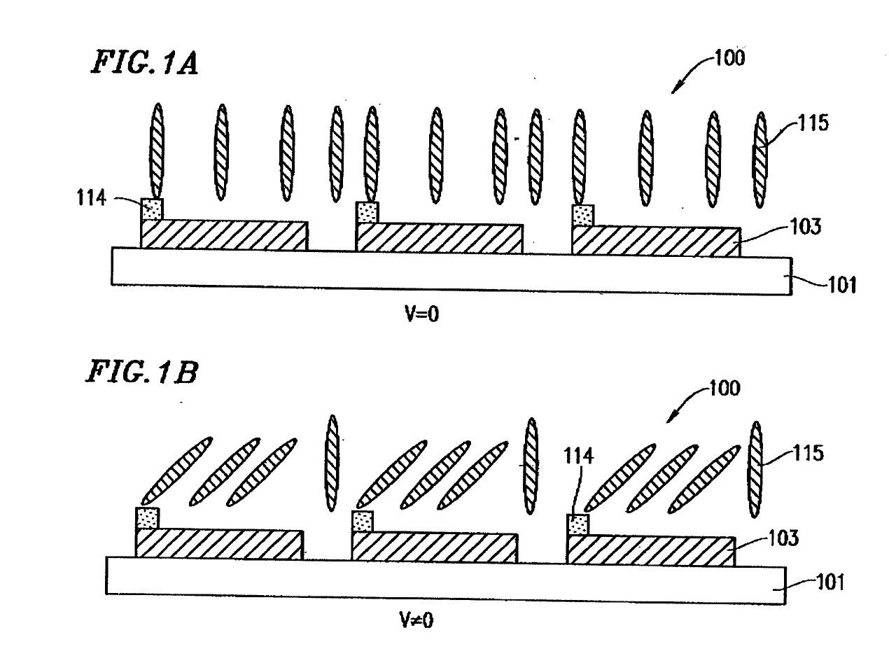

FIG. 1A is a cross-sectional view illustrating an LC display apparatus 100 according to Example 1 of the present invention in the absence of an applied electric field. FIG. 1B is a cross-sectional view illustrating the LC display apparatus 100 according to Example 1 of the present invention under an applied electric field. A counter substrate, electrodes, alignment films, and like elements are omitted from illustration in FIGS. 1A and 1B. The LC display apparatus 100 has a very simple structure as compared to that of the conventional LC display apparatus 2100 illustrated in FIGS. 21A and 21B. Specifically, a protrusion 114 is provided along only one side edge of each electrode 103. As a result, the tilting direction of LC molecules 115 is controlled, thereby realizing a display function free from disclination. Since the electrodes 103 are in a matrix arrangement, no electric field is applied in portions where there are no electrodes 103 (i.e., the “non-pixel portions”); therefore the LC molecules 115 in the non-pixel portions always remain in a vertical alignment. In addition, the LC molecules 115 do not tilt in opposite directions, unlike the LC molecules 2115 in the conventional LC display apparatus 2100 shown in FIGS. 21A and 21B which hinder each other's movement. Thus, a further enhancement in response speed from that obtained with one-dimensional disclination can be achieved.

The protrusions 114 can be formed by using a photosensitive resin.

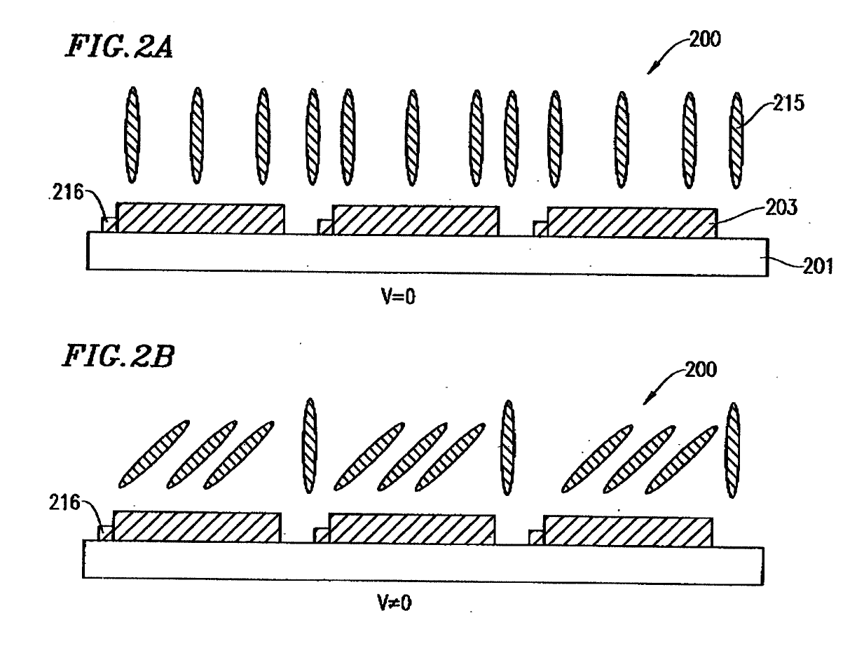

Alternatively, as in an LC display apparatus 200 illustrated in FIGS. 2A and 2B, a concave stepped portion 216 may be provided along only one side edge of each electrode 203 instead of the protrusion 114, such that the concave stepped portion 216 defines a lower surface than that of the electrode 203. Such a concave stepped portion 216 can be formed by applying a half-cut technique to the electrodes 203.

The LC molecules tilt in one direction due to excluded volume effects provided by the protrusions 114 or the concave stepped portions 216 (hence such protrusions or concave stepped portions may hereinafter be referred to as “volume excluding members”). Due to the continuous-nature of LC, such a tilt of the LC molecules uniformly continues from a side edge along which the protrusion 114 or a concave stepped portion 216 to an opposite side edge.

Alternatively, such protrusions 114 or concave stepped portions 216 may be provided on a counter substrate, or on both substrates.

Furthermore, viewing angle characteristics are also important for obtaining high-quality displayed images. In the case of the two-dimensional disclination of the LC display apparatus 2100 shown in FIGS. 21A and 21B, sufficient viewing angle characteristics are secured around 360° by ensuring that LC molecules will be caused to move in multiple azimuths within each pixel. However, in accordance with the LC display apparatus 100 according to the present invention as illustrated in FIGS. 1A and 1B, the viewing angle characteristics may deteriorate because LC molecules will be caused to move in only one azimuth within each pixel. FIG. 3A is a plan view illustrating the LC display apparatus 300. FIG. 3B is a cross-sectional view illustrating the LC display apparatus 300. As seen from FIGS. 3A and 3B, the viewing angle characteristics may deteriorate because LC molecules 115 will be caused to move in only one azimuth within each pixel. In FIG. 3A, the dotted line represents a horizontal line of the substrate. In the present example, the electrodes 103 have a substantially rectangular shape.

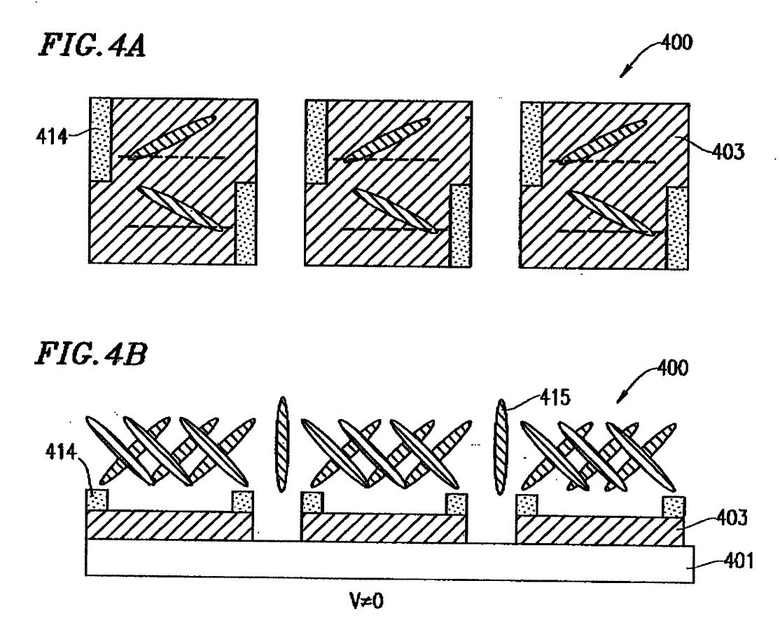

Accordingly, as shown in FIGS. 4A and 4B, protrusions 414 or concave stepped portions (not shown) may be provided along portions of two opposite side edges of each pixel in such a manner that the protrusions 414 or concave stepped portions (not shown) do not oppose each other, thereby preventing LC molecules 415 moving in opposite directions from colliding with each other in the central portion of each pixel. As a result, the LC molecules 415 can be caused to move in two directions which are 180° apart, without allowing disclination to occur. Thus, the viewing angle characteristics in either the right-left or up-down direction can be improved while maintaining fast response.

In such an embodiment as well, such protrusions 414 or concave stopped portions may be provided on a counter substrate, or on both substrates.

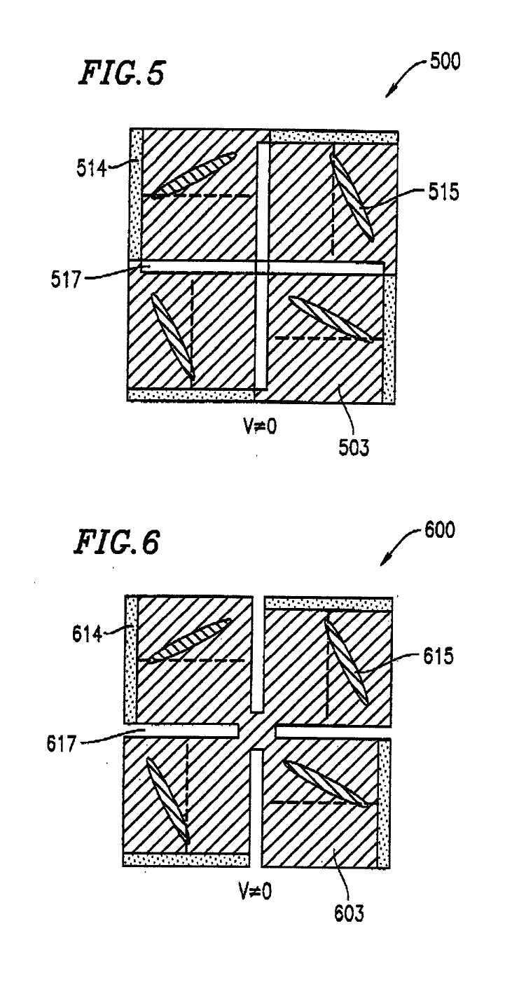

Furthermore, the viewing angle characteristics around 360° can be improved while maintaining fast response. For example, as seen from FIG. 5, which is a plan view illustrating an LC display apparatus 500, a window portion (i.e., a non-conductive portion) 517 may be provided within each pixel electrode 503, such that the window portion 517 divides one pixel in four or more subpixel regions, and a protrusion 514 or concave stepped portion (not shown) may be provided along one side edge of each subpixel region. Such protrusions or concave stopped portions 514 are preferably provided on four different subpixel side edges within each pixel. As a result, under an applied electric field, LC molecules 515 can be caused to move in four different directions, 90° apart, without allowing disclination to occur. Thus, viewing angle characteristics around 360° can be improved while maintaining a fast response. A variant of the structure of FIG. 5 is shown in FIG. 6. In an LC display apparatus 600 shown in FIG. 6, a window portion 617 does not completely, but does substantially, divide one pixel into four subpixel regions. The configuration of the window portion 517 or 617 is not limited to that for dividing each pixel into four subpixel regions, but further division is possible without departing from the scope of the invention. A greater number of subpixel regions is more advantageous for the sake of expanding viewing angles.

Alternatively, such window portions, protrusions, and/or concave stepped portions may be provided on a counter substrate, or on both substrates. Alternatively, such protrusions or concave stepped portions may be provided on one substrate, while window portions may be provided on the other substrate.

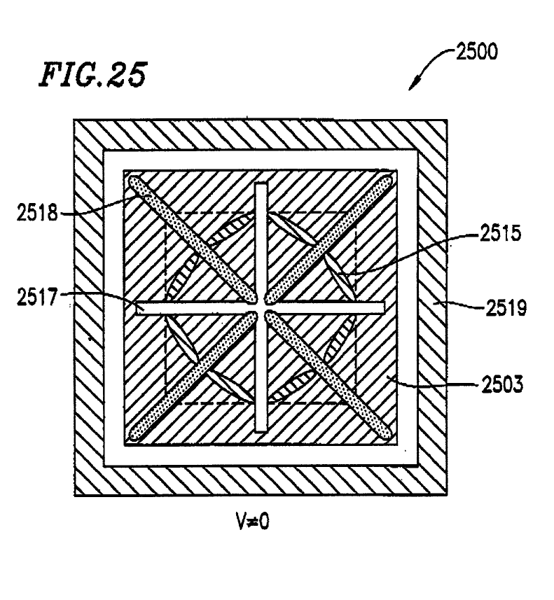

It should be noted that although an apparently similar structure is disclosed in Japanese Laid-open Patent Publication No. 7-199190, as seen from FIG. 25, which is a plan view illustrating an LC display apparatus 2500, the disclosed structure thereof includes an electrode 2519 for orientation controlling purposes provided around each pixel electrode 2503. Although the viewing angle characteristics are improved by this structure, disclination 2518 occurs for each subpixel region as shown in FIG. 25, so that the response speed is not substantially improved from the conventional level.

Hereinafter, the present invention will be further described by way of illustrative examples; however, the scope of the present invention is not limited to such specific examples.

### EXAMPLE 1

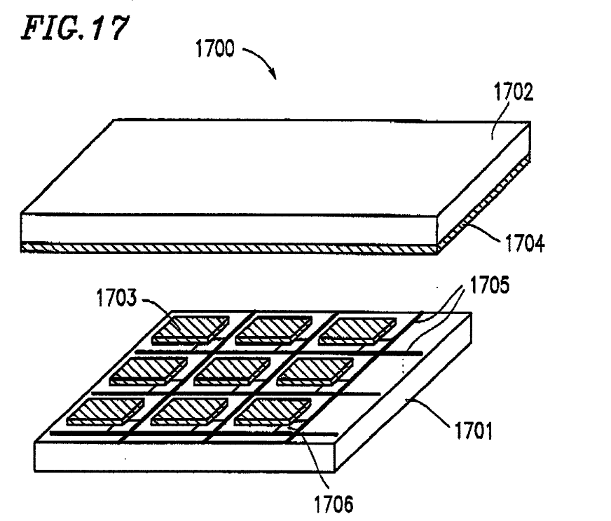

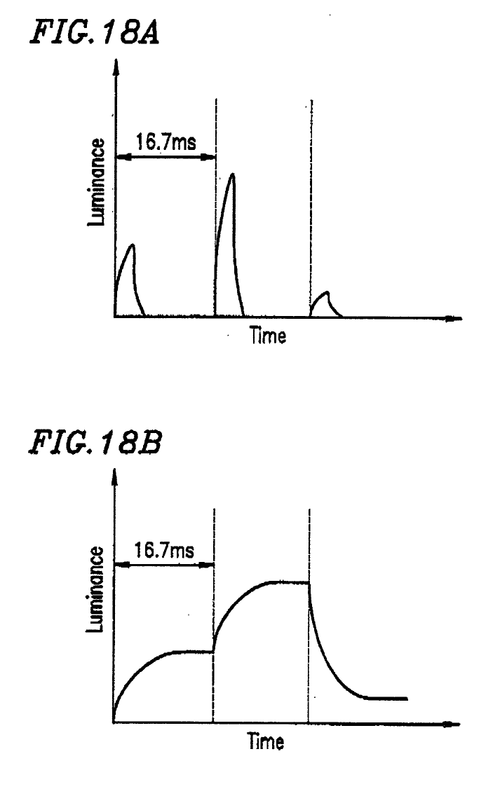

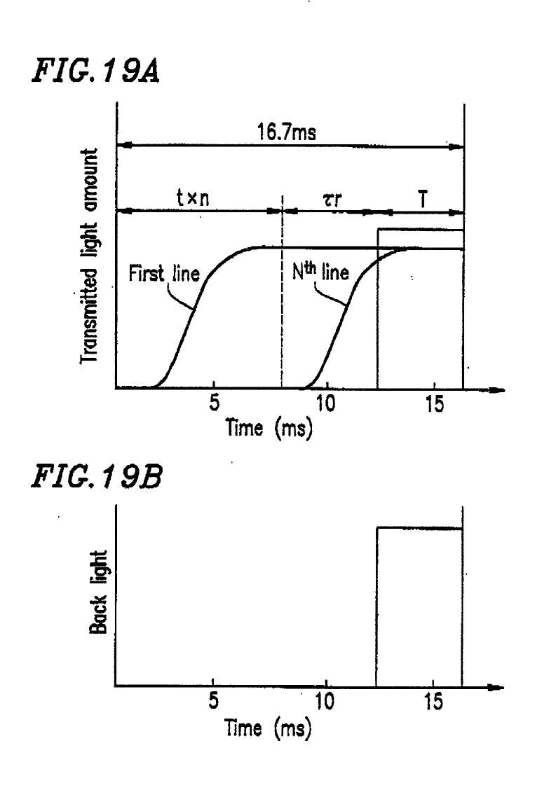

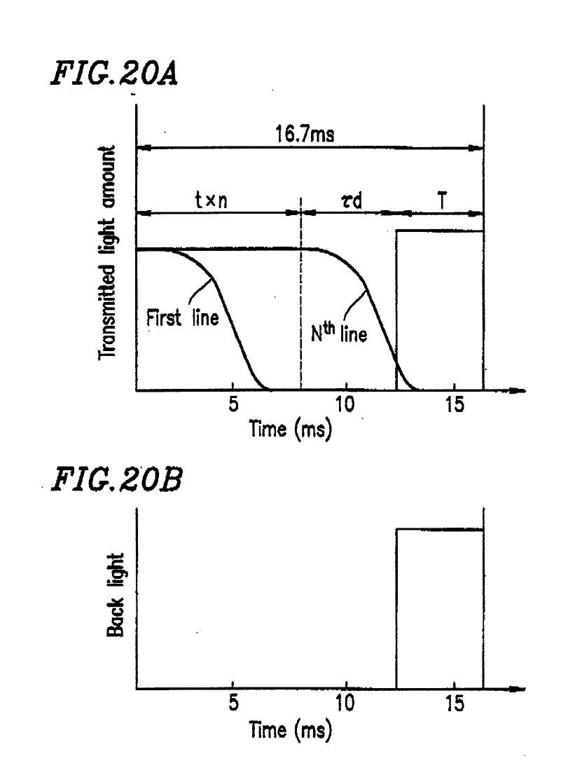

As Example 1 of the present invention, an LC display apparatus 100 shown in FIGS. 1A and 1B was produced as follows. Signal wiring (i.e., scanning lines and signal lines) and TFT elements (as switching elements) as shown in FIG. 17 were formed on a glass substrate 101. A transparent electrode film of ITO (thickness: 1000 Å) was formed so as to be in contact with the glass substrate, thereby forming a matrix electrode substrate. The ITO film was patterned into pixel electrodes 103 sized 300 μm×300 μm each. A piece of photosensitive resin BPR107 (Japan Synthetic Rubber Co., Ltd.), having a width of 10 μm and a thickness of 1 μm, was formed as a protrusion 114 overlying one side edge of each pixel electrode 103.

A transparent electrode (counter electrode) of ITO (thickness: 1000 Å) was formed on another glass substrate to form a counter substrate.

A vertical alignment film JALS-204 (Japan Synthetic Rubber Co., Ltd.) was formed on the side of each substrate on which the electrode(s) was(were) formed.

The two substrates were attached to each other to obtain a call thickness of 3 μm. Nematic liquid crystal MJ95955 (Merck & Co., Inc.) was injected into the cell, whereby an LC cell according to Example 1 was completed. This LC material has a dielectric anisotropy of −3.3.

The resultant LC cell was interposed between a pair of polarization plates placed in a cross-nicol arrangement and operated so as to be observed in the absence of an applied voltage, whereby a very excellent dark display state was exhibited. The amount of transmitted light was measured using a backlight (10000 cd/m²) for irradiating the LC cell. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e. without the LC cell) was 2.1 cd/m². Thus, there was substantially no change in the transmitted light amount. Next, a rectangular wave electric field (120 Hz) was applied. As a result, the pixel portions began to brighten up in the neighborhood of 1.5 V. As the applied voltage was increased, the amount of transmitted light increased, until reaching 1900 cd/m² at 5 V. A contrast of 800 or more was obtained.

An observation with a microscope revealed absence of disclination, which would always be observed in a conventional VA mode. As a result of measuring the response time of the Lc by using a photodiode and an oscilloscope, the LC cell was confirmed to have a rising time of 1 ms and a falling time of 0.8 ms, indicative of a significantly faster response than that attained by a conventional VA mode.

The viewing angle characteristics of this LC display apparatus 100 were measured, which revealed that the contrast decreases to 50 or less in any direction at 20° away from the frontal direction, and 5 or less at 50° away from the frontal direction, indicative of insufficient viewing angle characteristics.

### EXAMPLE 2

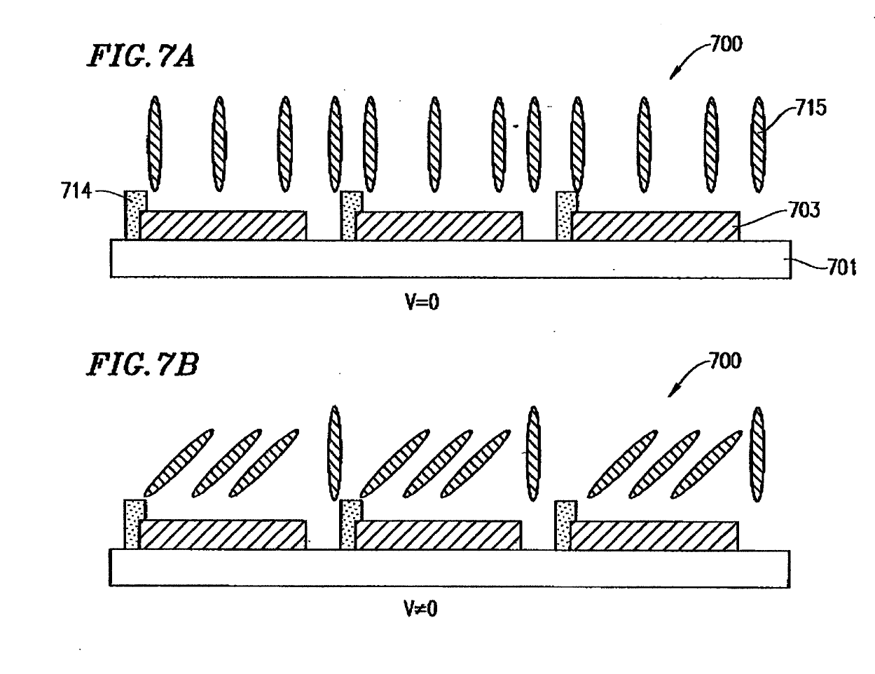

As Example 2 of the present invention, an LC display apparatus 700 shown in FIGS. 7A and 73 was produced in the same manner as in Example 1. except that a piece of photosensitive resin BPR107 (Japan Synthetic Rubber Co., Ltd.) was formed as a protrusion 714 contacting, but only partially overlying one side edge of each pixel electrode 103. FIG. 7A is a cross-sectional view illustrating the LC display apparatus 700 in the absence of an applied electric field. FIG. 7B is a cross-sectional view illustrating the LC display apparatus 700 under an applied electric field.

The resultant LC cell was interposed between a pair of polarization plates placed in a cross-nicol arrangement and operated so as to be observed in the absence of an applied voltage, whereby a very excellent dark display state was exhibited. The amount of transmitted light was measured using a backlight (10000 cd/m²) for irradiating the LC cell. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount. Next, a rectangular wave electric field (120 Hz) was applied. As a result, the pixel portions began to brighten up in the neighborhood of 1.5 V. As the applied voltage was increased, the amount of transmitted light increased, until reaching 1900 cd/m² at 5 V. A contrast of 800 or more was obtained.

An observation with a microscope revealed absence of disclination, which would always be observed in a conventional VA mode. As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode.

The viewing angle characteristics of this LC display apparatus 700 were measured, which revealed that the contrast decreases to 50 or less in any direction at 20° away from the frontal direction, and 5 or less at 50° away from the frontal direction, indicative of insufficient viewing angle characteristics,

### EXAMPLE 3

As Example 3 of the present invention, an LC display apparatus 200 shown in FIGS. 2A and 2B was produced in the same manner as in Examples 1 and 2, except that one side edge of each pixel electrode 203 composed of an ITO film was half-cut with laser radiation to form a concave stepped portion 216 (width: 10 μm). FIG. 2A is a cross-sectional view illustrating the LC display apparatus 200 in the absence of an applied electric field. FIG. 2B is a cross-sectional view illustrating the LC display apparatus 200 under an applied electric field. A counter substrate, electrodes, alignment films, and like elements are omitted from illustration in FIGS. 2A and 2B.

The resultant LC cell was interposed between a pair of polarization plates placed in a cross-nicol arrangement and operated so as to be observed in the absence of an applied voltage, whereby a very excellent dark display state was exhibited. The amount of transmitted light was measured using a backlight (10000 cd/m²) for irradiating the LC cell. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e. without the LC cell) was 2.1 cd/m². Thus, there was substantially no change in the transmitted light amount. Next, a rectangular wave electric field (120 Hz) was applied. As a result, the pixel portions began to brighten up in the neighborhood of 1.5 V. As the applied voltage was increased, the amount of transmitted light increased, until reaching 1900 cd/m² at 5 V. A contrast of 800 or more was obtained.

An observation with a microscope revealed absence of disclination, which would always be observed in a conventional VA mode. An a result of measuring the response time of the LC by using a photodiode and an oscilloscope, the LC cell was confirmed to have a rising time of 1 ms and a falling time of 0.8 ms, indicative of a significantly faster response than that attained by a conventional VA mode.

The viewing angle characteristics of this LC display apparatus 200 were measured, which revealed that the contrast decreases to 50 or less in any direction at 20° away from the frontal direction, and 5 or less at 50° away from the frontal direction, indicative of insufficient viewing angle characteristics.

### EXAMPLE 4

As Example 4 of the present invention, an LC display apparatus 400 shown in FIGS. 4A and 4B was produced in the same manner as in Examples 1 to 3, except that a photosensitive resin was formed on a portion of each of two opposite side edges of each pixel electrode 403 as a protrusion 414, such that the two protrusions 414 in each pixel did not oppose each other. As an alternative, a portion of each of two opposite side edges of each pixel electrode 403 was half-cut to form a concave stepped portion, such that two concave stepped portions in each pixel did not oppose each other. A counter substrate, electrodes, alignment films, and like elements are omitted from illustration in FIGS. 4A and 4B.

The resultant LC cell was interposed between a pair of polarization plates placed in a cross-nicol arrangement and operated so as to be observed in the absence of an applied voltage, whereby a very excellent dark display state was exhibited, The amount of transmitted light was measured using a backlight (10000 cd/m²) for irradiating the LC cell. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount. Next, a rectangular wave electric field (120 Hz) was applied. As a result, the pixel portions began to brighten up in the neighborhood of 1.5 V. As the applied voltage was increased, the amount of transmitted light increased, until reaching 1900 cd/m² at 5 V. A contrast of 800 or more was obtained.

An observation with a microscope revealed absence of disclination, which would always be observed in a conventional VA mode. As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode.

The viewing angle characteristics of this LC display apparatus 500 were measured, which revealed that the contrast decreases to 50 or less in any direction (.other than the longitudinal direction of the protrusions 414 or the short side direction of the concave stepped portions) at 20° from the frontal direction, and 5 or less at 50° from the frontal direction, indicative of insufficient viewing angle characteristics. However, in the longitudinal direction of the protrusions 414 or the short side direction of the concave stepped portions, there was a high contrast of 500 or more even at 50° from the frontal direction, and a somewhat lesser contrast of 200 or more at 70° from the frontal direction, indicative of a high contrast over a sufficiently broad range of viewing angles.

### EXAMPLE 5

As Example 5 of the present invention, an LC display apparatus 500 shown in FIG. 5 was produced in the same manner as in Examples 1 to 4, except that a photosensitive resin was formed so as to overlie One side edge of each of four subpixel regions, into which each pixel electrode 503 was divided by a window portion 517 etched in a central portion of the pixel electrode 503, such that protrusions 514 were provided on four different subpixel side edges within each pixel. As an alternative, one side edge of each of four subpixel regions was half-cut to form a concave stepped portion, such that concave stepped portions were provided on four different subpixel side edges within each pixel.

The resultant LC cell Was interposed between a pair of polarization plates placed in a cross-nicol arrangement and operated so as to be observed in the absence of an applied voltage, whereby a very excellent dark display state was exhibited. The amount of transmitted light was measured using a backlight (10000 cd/m²) for irradiating the LC cell. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount. Next, a rectangular wave electric field (120 Hz) was applied. As a result, the pixel portions began to brighten up in the neighborhood of 1.5 V. As the applied voltage was increased, the amount of transmitted light increased, until reaching 1900 cd/m² at 5 V. A contrast of 800 or more was obtained.

An observation with a microscope revealed absence of disclination, which would always be observed in a conventional VA mode. As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode.

The viewing angle characteristics of this LC display apparatus 500 were measured, which revealed that there was a high contrast of 500 or more even at 50° from the frontal direction, and a somewhat lesser contrast of 200 or more at 70° from the frontal direction, indicative of a high contrast over a sufficiently broad range of viewing angles.

### EXAMPLE 6

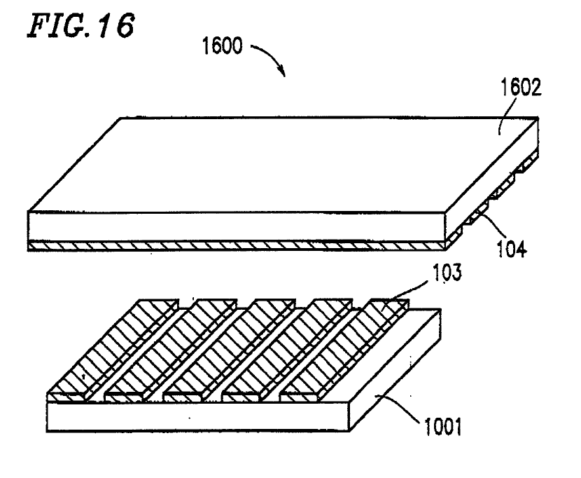

According to Example 6, the present invention is applied to various simple matrix type LC display apparatuses as shown in FIG. 16. In a manner similar manner to Examples 1 to 5, protrusions, concave stepped portions, and/or window portions were provided on one substrate.

Although the contrast of the resultant LC display apparatuses was reduced to about 150 due to crosstalk, an excellent display quality was obtained as compared with that provided by a conventional simple matrix type LC display apparatus. The LC display apparatuses had as good an LC response speed and viewing angle characteristics as attained in Examples 1 to 5.

### EXAMPLE 7

According to Example 7, the present invention is applied to various simple matrix type LC display apparatuses as shown in FIG. 16. In a manner similar manner to Examples 1 to 5, protrusions, concave stepped portions, and/or window portions were provided on both substrates.

Although the contrast of the resultant LC display apparatuses was reduced to about 150 due to crosstalk, as in Example 6, an excellent display quality was obtained as compared with that provided by a conventional simple matrix type LC display apparatus. The LC display apparatuses had as good an LC response speed and viewing angle characteristics as attained in Examples 1 to 6.

### EXAMPLES 8-11

Examples 1 to 7, described above, are directed to embodiments in which LC molecules in the non-pixel portions are oriented in a vertical alignment.

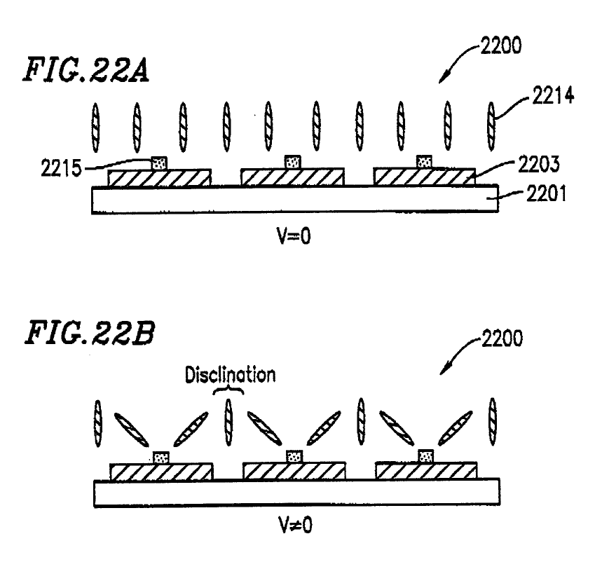

FIG. 22A shows a cross section of a VA mode LC display apparatus 2200 in the absence of an applied electric field. FIG. 22B shows a cross section of the VA mode LC display Apparatus 2200 under an applied electric field. A counter substrate, electrodes, alignment films, and like elements are omitted from illustration in FIGS. 22A and 22B.

As shown in FIG. 22A, LC molecules 2214 are oriented in a vertical alignment under no applied voltage. However, under an applied voltage as shown in FIG. 22B, the LC molecules 2214 above electrodes 2203 are realigned toward the protrusions 2215. As a result, LC molecules in any disclinated portions in regions (i.e., non-pixel portions) other than the pixel electrodes 2203 collide with LC molecules on both sides, whereby the movement of the LC is hindered. Thus, it is presumed that the response speed decreases when there is more disclination, and that the response speed increases when there is less disclination. Since the VA mode is susceptible to multiple instances of disclination within each display pixel, it may result in a relatively slow response speed, and a relatively low brightness and/or luminance.

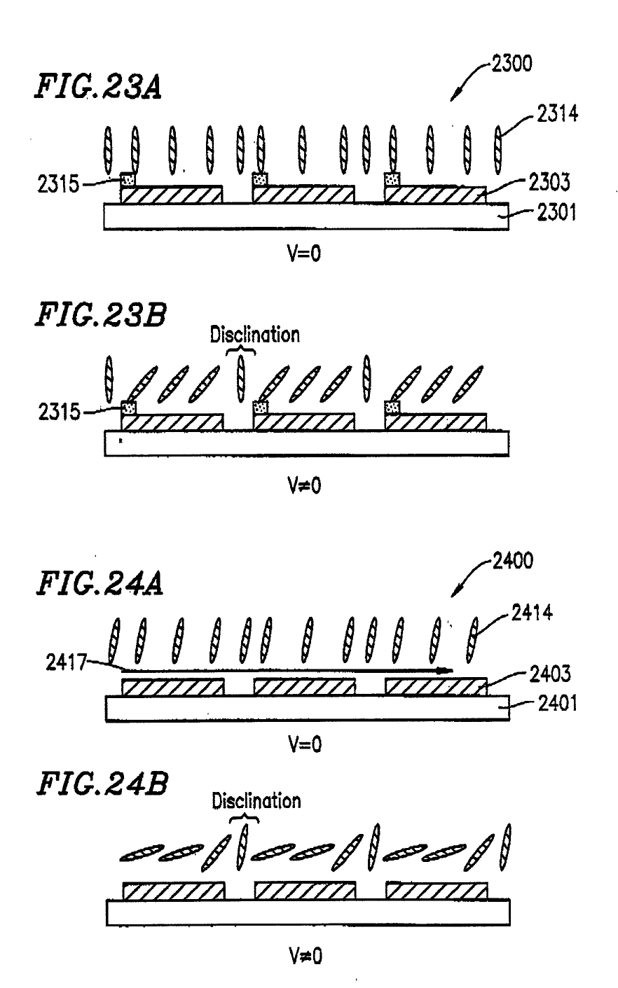

In the structure shown in FIGS. 22A and 22B, a protrusion 2215 is provided on a portion of an electrode 2203 within each pixel in order to restrain disclination so as to occur only in non-pixel portions, thereby improving the luminance. However, the relatively slow response speed due to hindered LC movement is still not quite improved this problem still remains even if a rubbing 2417 is performed in the manner shown in FIGS. 24A and 24B in order to orient LC molecules in a vertical alignment as described in Japanese Laid-Open Patent Publication No. 11-44885, As seen from FIGS. 22A, 22D, 23A, 23B, 24A, and 24D, the problem arises from the fact that, since LC molecules are oriented in a vertical alignment in the non-pixel portions, any LC molecules in the pixel portions being tilted to take a horizontal alignment will collide therewith, hindering the LC molecule movement. Therefore, it, is necessary to prevent disclination at boundaries between the pixel portions and the non-pixel portions for further enhancement of response speed.

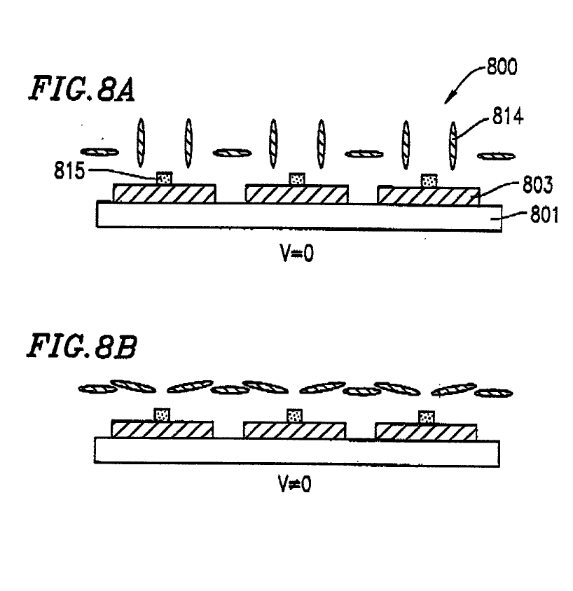

Hereinafter, Examples 8 to 11 of the present invention will be generally described first, and then described in detail as to their possible variants. Each of Examples 8-11 has six variants as indicated by the suffixes −1 to −6. Sub-examples indicated by the suffixes -1 to -6 correspond to FIGS. 8A/8B, 10A/10B, 11A/11B, 12A/12B, 13A/13B, and 14A/14B, respectively.

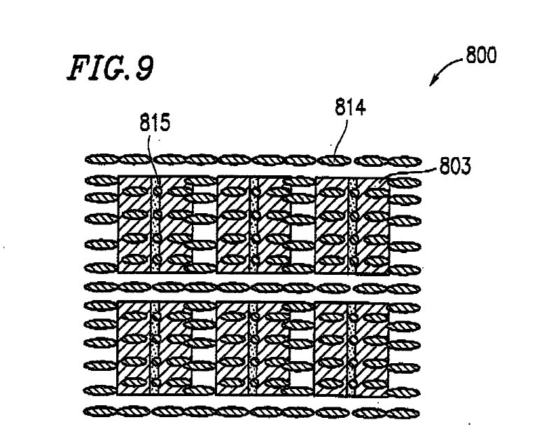

FIGS. 8A and 8B (corresponding to the “−1” variants of Examples 8 to 11) are cross-sectional views Illustrating the structure of an LC display apparatus 800 according to the present invention. FIG. 8A shows a cross section of the LC display apparatus 800 in the absence of an applied electric field. FIG. 8B shows a cross section of the LC display apparatus 800 under an applieb electric field. As in an LC display apparatus 2200 whose cross section is shown in FIGS. 22A and 22B, protrusions 815 are provided on electrodes 803, which in turn are provided on a substrate 801. LC molecules 814 are present above this structure. A counter substrate, electrodes, alignment films, etc. are omitted from these figures. In accordance with the LC display apparatus 800, the LC molecules in non-pixel portions are oriented in a horizontal alignment in the absence of an applied voltage, as opposed to the vertical alignment as in the LC display apparatus 2200. This prevents collision with the LC molecules which shift from a vertical alignment to a horizontal alignment in pixel portions, whereby hindrance of response is minimized. The generation of disclination is substantially completely eliminated over the entire LC display apparatus 800, thereby further enhancing the response speed. In order to attain substantially complete elimination of collision between LC molecules, as shown in FIG. 9 (a plan view showing the LC display apparatus 800), it is important to also ensure a uniaxial alignment such that the orientation of the horizontally-aligned LC molecules 814 in the non-pixel portions coincides with a direction in which the LC molecules 814 will tilt in the pixel portions.

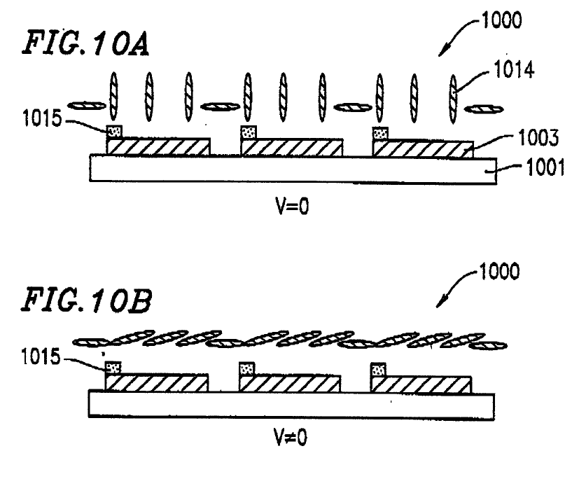

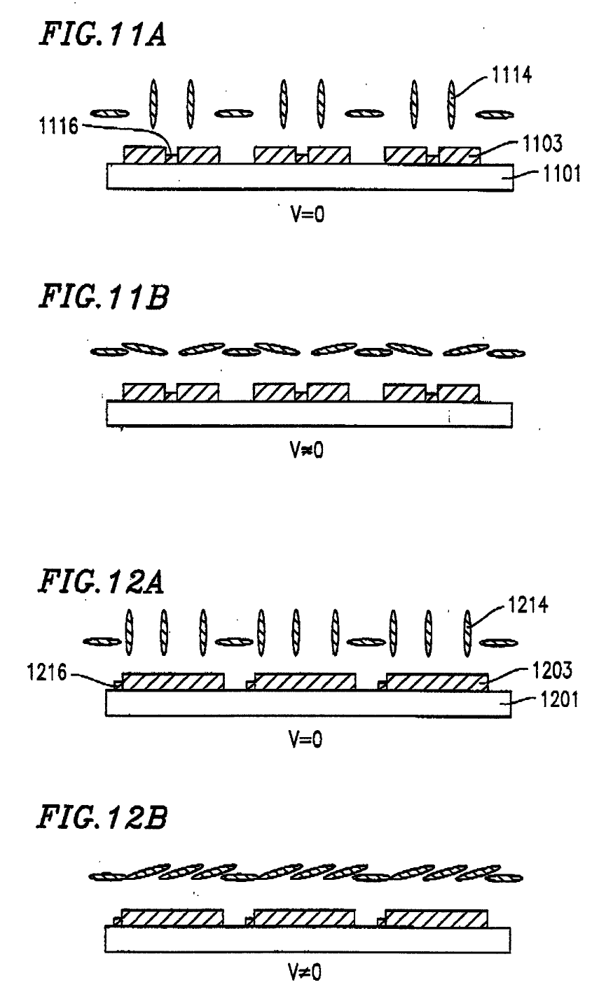

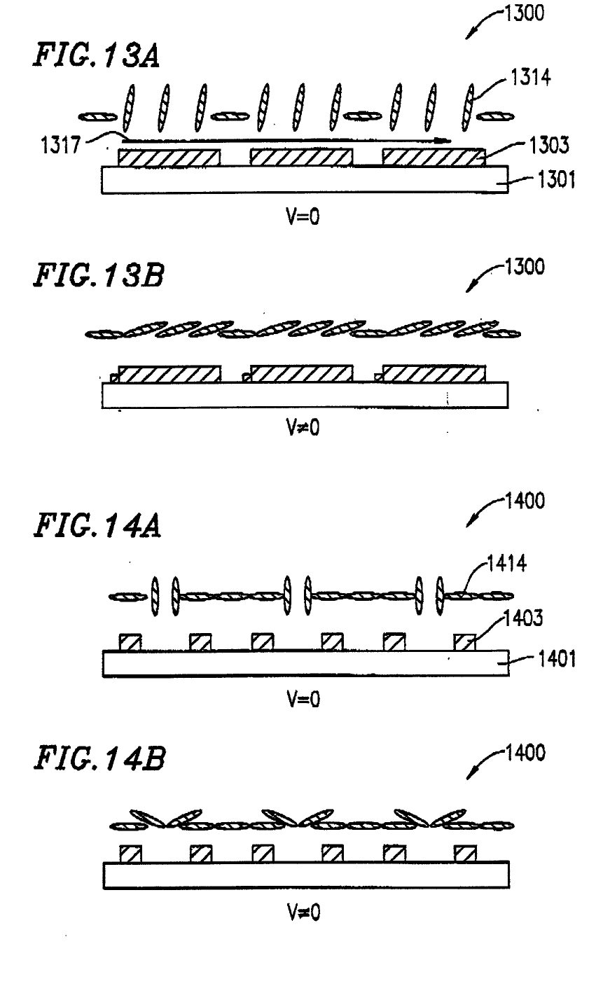

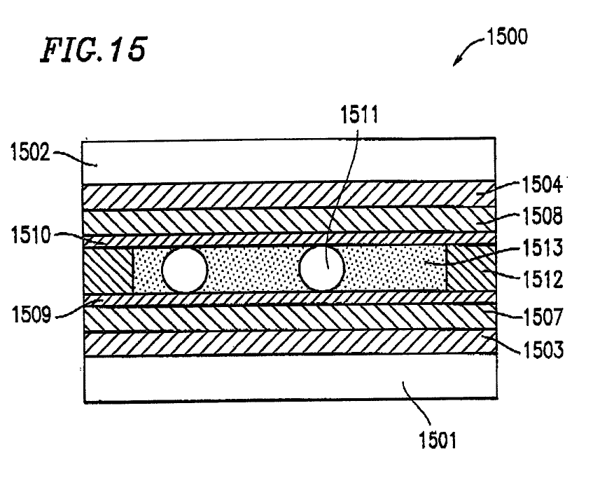

Similar effects can be obtained with protrusions 1015 provided in an LC display apparatus 1000 shown in FIGS. 10A and 10B (corresponding to the “−2” variants of Examples 8 to 11). Alternatively, similar effects can also be obtained with concave stepped portions 1116 provided in electrodes 1103 of an LC display apparatus 1100 shown in FIG. 11 (corresponding to the “−3” variants of Examples 8 to 11), or with concave stepped portion 1216 provided in electrodes 1203 of an LC display apparatus 1200 shown in FIG. 12 (corresponding to the “−4” variants of Examples 8 to 11). Such concave stepped portion 1116 or 1216 serve to control the direction in which LC molecules are tilted, similar to protrusions 805 or 1015. Alternatively, similar effects can also be obtained with a rubbing (as indicated by an arrow 13) as in an LC display apparatus 1300 shown in FIGS. 13A and 13B (corresponding to the “−5” variants of Examples 8 to 11). FIG. 13A shows a cross section of the LC display apparatus 1300 in the absence of an applied electric field. FIG. 13B shows a cross section of the LC display apparatus 1300 under an applied electric field. The respective LC display apparatuses shown in FIGS. 8A/8B, 10A/10B, 11A/11B, 12A/12B, 13A/13B operate in a VA mode such that the respective LC display apparatus is switched via selective application of an electric field which is in a direction perpendicular to the substrate surface; therefore, an LC material having a negative dielectric anisotropy Δε. In an LC display apparatus 1400 shown in FIGS. 14A and 14B (corresponding to the “−6” variants of Examples 8 to 11, which operates in a VA mode such that the LC display apparatus is switched via selective application of an electric field which is in a direction parallel to the substrate surfaces, an LC material having a positive dielectric anisotropy Δε is used. Similar effects can be obtained by orienting the LC molecules in the non-pixel pixel portions in a horizontal alignment. FIG. 14A shows a cross section of the LC display apparatus 1400 in the absence of an applied electric field. FIG. 14B shows a cross section of the LC display apparatus 1400 under an applied electric field.

There has been a long history of attempts of applying different alignment treatments for pixel portions and non-pixel portions. For example, as described in Japanese Laid-Open Patent Publication Nos. 59-78318, 5-93912, and 6-3675, it is well-known to introduce a horizontal alignment in pixel portions and a vertical alignment in non-pixel portions. However, these techniques are directed to LC display apparatuses which perform a display function in cooperation with a pair of polarizing plates in a cross-nicol state, where a vertical alignment is introduced in the non-pixel portions for the sole purpose of improving the quality of a dark display state.

In contrast, according to the present invention, a vertical alignment is introduced to LC molecules in the pixel portions, whereas a horizontal alignment is introduced to LC molecules in the non-pixel portions with a uniaxial alignment, with a view to further enhancing the response speed of a VA mode. According to the present invention, the non-pixel portions no longer serve to display a dark state, which in itself might appear to be detrimental to the display quality. However, in actual implementation, a black matrix can be conveniently employed to prevent reflection from a TFT array 1706 and/or wiring 1705 (FIG. 17). Thus, the inability of the non-pixel portions to display a dark state according to the present invention is not a problem because the non-pikel portions will be concealed by the black matrix.

There are several methods for maintaining a uniaxial horizontal Alignment of LC molecules in the non-pixel portions. The simplest method is to selectively form horizontal alignment films in the non-pixel portions and apply a usual rubbing treatment thereto. A method which does not involve selective formation of horizontal alignment films is to form a vertical alignment film over the entire substrate surface and selectively modify the non-pixel portions through a chemical process. Examples of applicable chemical processes include: an acid process or an alkali process using a resist for protecting the pixel portions; and selective ultraviolet ray irradiation through a photomask. While such chemical processes can destroy vertical alignment and provide horizontal alignment, it is difficult to impart a uniaxial arrangement to the horizontal alignment. Therefore, it is desirable to also use rubbing. A method which does not involve rubbing treatments is to irradiate ultraviolet rays which have been linearly polarized in a particular direction. With this method, it is possible to impart uniaxialness in accordance with the polarization direction of the ultraviolet rays.

Hereinafter, the variants, indicated by the suffixes −1 to −6, of Examples 8 to 11 of the present invention will be specifically described.

### EXAMPLE 8-1

As an example of the present invention, an LC display apparatus was produced as follows, TFT elements were formed on a glass substrate. A transparent electrode film of ITO (thickness: 100 Å) was formed so as to be in contact with the glass substrate, thereby forming a matrix electrode substrate. The ITO film was patterned into pixel electrodes sized 300 μm×300 μm each. A piece of photosensitive resin BPR107 (Japan Synthetic Rubber Co., Ltd.), having a width of 10 μm and a thickness of 1 μm, was formed as a protrusion 815 in the central portion of each ITO pixel in the manner shown in FIGS. 8A and 8B. A transparent electrode film of ITO (thickness: 1000 Å) was formed on another glass substrate to form a counter substrate.

A horizontal alignment film LQT-120 (Hitachi Chemical Co., Ltd.) was formed on the side of each substrate on which the electrode(s) was (were) formed, and a rubbing treatment was applied to both substrates in parallel directions to each other. The rubbing direction was perpendicular to the longitudinal direction of the protrusions. Upon this, a vertical alignment film JALS-955 (Japan Synthetic Rubber Co., Ltd.) was formed, and a positive type photoresist was further formed thereon. Thereafter, exposure and development were carried out by using a photomask for shielding the pixel portions only, and the photoresist in the non-pixel portions was removed. Through a timed dry etching using an O₂ plasma, the vertical alignment film JALS-955 in the non-pixel portions was removed. After removing the resist in the pixel portions, the two substrates were attached to each other to obtain a cell thickness of 3 μm. Nematic liquid crystal MJ95955 (Merck & Co., Inc.) was injected into the cell, whereby an LC cell was completed. This LC material has a dielectric anisotropy of −3.3.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 8-2

As an example of the present invention, an LC display apparatus was produced in the same manner as in Example 8-1, except that a piece of photosensitive resin BPR107 (Japan Synthetic Rubber Co., Ltd.) was formed as a protrusion 1015 along a side edge of each ITO pixel (i.e., electrode 1003) in the manner shown in FIGS. 10A and 10B.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V, Thus, a contrast of 800 or more was obtained. An observation with a microscope revealed total absence of disclination, which would always be observed in a conventional VA mode, even at boundaries between the pixel And the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 8-3

As an example of the present invention, an LC display apparatus was produced in the same manner as in Example 8-1, except that a concave stepped portion 1116 was formed in the central portion of each ITO pixel (i.e., electrode 1103) in the manner shown in FIGS. 1A and 1B by a laser half-cut technique, instead of forming a protrusion of photosensitive resin BPR107 (Japan Synthetic Rubber Co., Ltd.). The rubbing direction was perpendicular to the longitudinal direction of the concave stepped portions 1116.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was' uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing. the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross -nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 8-4

As an example of the present invention, an LC display apparatus was produced in the same manner as in Example 8-1, except that a concave stepped portion 1216 was formed along a side edge of each ITO pixel in the manner shown in FIGS. 12A and 12B by a laser half -cut technique, instead of forming a protrusion of photosensitive resin BPR107 (Japan Synthetic Rubber Co., Ltd.). The rubbing direction was perpendicular to the longitudinal direction of the concave stepped portions 1216.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode.

The response times for eight gray scale levels with respect to eight variations of transmitted light amounts (8×8=64 states) were also confirmed to be all equal to or less than 2.5 ms, indicative of a very fast response.

### EXAMPLE 8-5

As an example of the present invention, an LC display apparatus was produced as follows. TFT elements were formed on a glass substrate. A transparent electrode film of ITO (thickness: 1000 Å) was formed so as to be in contact with the glass substrate, thereby forming a matrix electrode substrate. The ITO film was patterned into pixel electrodes sized 300 μm×300 μm each. A transparent electrode film of ITO (thickness: 1000 Å) was formed on another glass substrate to form a counter substrate.

A horizontal alignment film LQT-120 (Hitachi Chemical Co., Ltd.) was formed on the side of each a substrate on which the electrode(s) was(were) formed, Upon this, a vertical alignment film JALS-955 (Japan Synthetic Rubber Co., Ltd.) was formed, and a positive type photoresist was further formed thereon. Thereafter, exposure and development were carried out by using a photomask for shielding the pixel portions only, and the photoresist in the non-pixel portions was removed. Through a timed dry etching using an O₂ plasma, the vertical alignment film JALS-955 in the non-pixel portions was removed. After removing the resist in the pixel portions, a rubbing treatment (see FIG. 13A) was applied to both substrates in parallel directions to each other, and the two substrates were attached to each other to obtain a cell thickness of 3 μm. Nematic liquid crystal MJ95955 (Merck & Co., Inc.) was injected into the cell, whereby an LC cell was completed. This LC material has a dielectric anisotropy of −3.3.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e,, without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 8-6

As an example of the present invention, an LC display apparatus was produced as follows. TFT elements were formed on a glass substrate. By providing pairs of opposing comb electrodes 1403 as shown in FIGS. 14A and 14B thereon, a matrix electrode substrate was formed with which it is possible to apply an electric field in a direction parallel to the substrate surfaces. The pixel electrodes were each sized to be 100 μm×100 μm. Another glass substrate was used to form a counter substrate.

A horizontal alignment film LQT-120 (Hitachi Chemical Co., Ltd.) was formed on the side of each substrate on which the electrode(s) was (were) formed, and a rubbing treatment was applied to both substrates in parallel directions to each other. The rubbing direction was perpendicular to a direction in which each pair of comb electrodes opposed each other to define pixels. Upon this, a vertical alignment film JALS-955 (Japan Synthetic Rubber Co., Ltd.) was formed, and a positive type photoresist was further formed thereon. Thereafter, exposure and development were carried out by using a photonask for shielding the pixel portions only, and the photoresist in the non-pixel portions was removed. Through a timed dry etching using an O₂ plasma, the vertical alignment film JALS-955 in the non-pixel portions was removed. After removing the resist in the pixel portions, the two substrates were attached to each other to obtain a cell thickness of 3 μm. Nematic liquid crystal E7 (Merck & Co., Inc.) was injected into the cell, whereby an LC cell was completed. This LC material has a dielectric anisotropy of 13.8.

The resultant LC cell was interposed between a pair of polarization plates placed in a cross-nicol arrangement and operated so as to be observed in the absenoe of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m³. For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA modes The response times for eight gray scale levels with respect to eight variations of transmitted light amounts (8×8=64 states) were also confirmed to be all equal to or less than 2.5 ms, indicative of a very fast response.

### EXAMPLE 9-1

As an example of the present invention, an LC display apparatus was produced as follows, TFT elements were formed on a glass substrate. A transparent electrode film of ITO (thickness 1000 Å) was formed so as to be in contact with the glass substrate, thereby forming a matrix electrode substrate. The ITO film was patterned into pixel electrodes sized 300 μm×300 μm each. A piece of photosensitive resin BPR107 (Japan Synthetic Rubber Co., Ltd.), having a width of 10 μm and a thickness of 1 μm was formed as a concave stepped portion 815 in the central portion of each ITO pixel (i.e., electrode 803) in the manner shown in FIGS. 8A and 8B. A transparent electrode film of ITO (thickness: 1000 Å) was formed on another glass substrate to form a counter substrate.

A vertical alignment film JALS-955 (Japan Synthetic Rubber Co., Ltd.) was formed on the side of each substrate on which the electrode(s) was (were) formed, and a positive type photoresist was further formed thereon. Thereafter, exposure and development were carried out by using a photomask for shielding the pixel portions only, and the photoresist in the non-pixel portions was removed. While protecting the pixel portions with the photoresist, the substrates were immersed in a 1% aqueous solution of hydrofluoric acid for 1 minute, and then rinsed with purif id water, and subsequently dried. Next, a rubbing treatment was applied to both substrates in parallel directions to each other. The rubbing direction was perpendicular to the longitudinal direction of the protrusions. After removing the resist in the pixel portions, the two substrates were attached to each other to obtain a cell thickness of 3 μm. Nematic liquid crystal MJ95955 (Merck & Co., Inc.) was infected into the cell, whereby an LC cell was completed. This LC material has a dielectric anisotropy of −3.3.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As n result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mods. The response times for eight gray scale levels with respect to eight variations of transmitted light amounts (8×8=64 states) were also confirmed to be all equal to or less than 2.5 ms, indicative of a very fast response.

### EXAMPLE 9-2

As an example of the present invention, an LC display apparatus was produced in the same manner as in Example 9-1. except that a piece of photosensitive resin BPR107 (Japan Synthetic Rubber Co., Ltd.) was formed as aprotrusion 1015 along a side edge of each ITO pixel (i.e., electrode 1003) in the manner shown in FIGS. 10A and 10B.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²)while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e. , without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 9-3

As an example of the present invention, an LC display apparatus was produced in the same manner as in Example 9-1, except that a concave stepped portion 1116 was formed in the central portion of each ITO pixel (i.e., electrode 1103) in the manner shown in FIGS. 11A and 11B by a laser half-cut technique, instead of forming a protrusion of photosensitive resin BPR107 (Japan Synthetic Rubber Co., Ltd.). The rubbing direction was perpendicular to the longitudinal direction of the concave stepped portions 1116.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-niool arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more wan obtained. An observation with a microscope revealed total absence of disclination, which would always be observed in a conventional VA mode, even at boundaries between the pixel And the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 9-4

As an example of the present invention, an LC display apparatus was produced in the same manner as in Example 9-1, except that a concave stepped portion 1216 was formed along a side edge of each ITO pixel in the manner shown in FIGS. 12A and 12B by a laser half-cut technique, instead of forming a protrusion of photosensitive resin BPR107 (Japan Synthetic Rubber Co., Ltd.). The rubbing direction was perpendicular to the longitudinal direction of the Concave stepped portions 1216.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis, As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 me and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 9-5

As an example of the present invention, an LC display apparatus was produced as follows TFT elements were formed on a glass substrate. A transparent electrode film of ITO (thickness: 1000 Å) was formed so as to be in contact with the glass substrate, thereby forming a matrix electrode substrate. The ITO film was patterned into pixel electrodes sized 300 μm×300 μm each. A transparent electrode film of ITO (thickness: 1000 Å) was formed on another glass substrate to form a counter substrate.

A vertical alignment film JALS-955 (Japan Synthetic Rubber Co., Ltd.) was formed on the side of each substrate on which the electrode(s) was(were) formed, and a positive type photoresist was further formed thereon. Thereafter, exposure and development were carried out by using a photomask for shielding the pixel portions only, and the photoresist in the non-pixel portions was removed. While protecting the pixel portions with the photoresist, the substrates were immersed in a 1% aqueous solution of hydrofluoric acid for 1 minute, and then rinsed with purified water, and subsequently dried. Next, a rubbing treatment was applied to both substrates in parallel directions to each other. After removing the resist in the pixel portions, the two substrates were attached to each other to obtain a cell thickness of 3 μm. Nematic liquid crystal MJ95955 (Merck & Co., Inc.) was injected into the cell, whereby an LC call was completed. This LC material has a dielectric anisotropy of −3.3.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°, Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 9-6

As an example of the present invention, an LC display apparatus was produced as follows. TFT elements were formed on a glass substrate. By providing pairs of opposing comb electrodes 1403 as shown in FIGS. 14A and 14B thereon, a matrix electrode substrate was formed with which it is possible to apply an electric field in a direction parallel to the substrate surfaces. The pixel electrodes were each sized to be 100 μm×<100 μm. Another glass substrate was used to form a counter substrate.

A vertical alignment film JALS-955 (Japan Synthetic Rubber Co., Ltd.) was formed on the side of each substrate on which the electrode(s) was(were) formed, and a positive type photoresist was further formed thereon. Thereafter, exposure and development were carried out by using a photomask for shielding the pixel portions only, and the photoresist in the non-pixel portions was removed. While protecting the pixel portions with the photoresist, the substrates were immersed in a 1% aqueous solution of hydrofluoric acid for 1 minute, and then rinsed with purified water, and subsequently dried. Next, a rubbing treatment was applied to both substrates in parallel directions to each other. The rubbing direction was perpendicular to a direction in which each pair of comb electrodes opposed each other to define pixels. After removing the resist in the pixel portions, the two substrates were attached to each other to obtain a cell thickness of 3 μm. Nematic liquid crystal E7 (Merck & Co., Inc.) Was injected into the cell, whereby an LC cell was completed. This LC material has a dielectric anisotropy of 13.8.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination,. which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms indicative of a significantly faster response than that attained by a conventional VA mode. the response times for eight gray scale levels with respect to eight variations of transmitted light amounts (8×8=64 states) were also confirmed to be all equal to or less than 2.5 ms, indicative of a very fast response.

### EXAMPLE 10-1

As an example of the present invention, an LC display apparatus was produced as follows. TFT elements were formed on a glass substrate. A transparent electrode film of ITO (thickness: 1000 Å) was formed so as to be in contact with the glass substrate, thereby forming a matrix electrode substrate. The ITO film was patterned into pixel electrodes sized 300 μm×300 μm each. A piece of photosensitive resin BPR107 (Japan Synthetic Rubber Co., Ltd.), having a width of 10 μm and a thickness of 1 μm, was formed in the central portion of each ITO pixel in the manner shown in FIGS. 8A and 8B. A transparent electrode film of ITO (thickness: 1000 Å) was formed on another glass substrate to form a counter substrate.

A vertical alignment film JALS-955 (Japan Synthetic Rubber Co., Ltd.) was formed on the side of each substrate on which the electrode(s) was(were) formed. Ultraviolet rays (wavelength: 270 nm) were irradiated through a photomask for shielding the pixel portions only. A rubbing treatment was applied to both substrates in parallel directions to each other. The rubbing direction was perpendicular to the longitudinal direction of the protrusions. The two substrates were attached to each other to obtain a cell thickness of 3 μm. Nematic liquid crystal MJ95955 (Merck & Co., Inc.) was injected into the cell, whereby an LC cell was completed. This LC material has a dielectric anisotropy of −3.3.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the, transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 10-2

As an example of the present invention, an LC display apparatus was produced in the same manner as in Example 10-1, except that a piece of photosensitive resin BPR107 (Japan Synthetic Rubber Co., Ltd.) was formed as a protrusion 1015 along a side edge of each ITO pixel (i.e., electrode 1003) in the manner shown in FIGS. 10A and 10B.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC call was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 10-3

As an example of the present invention, an LC display apparatus was produced in the same manner as in Example 10-1, except that a concave stepped portion 1116 was formed in the central portion of each ITO pixel (i.e., electrode 1103) in the manner shown in FIGS. 11A and 11B by a laser half-cut technique, instead of forming a protrusion of photosensitive resin BPR107 (Japan Synthetic Rubber Co., Ltd.). The rubbing direction was perpendicular to the longitudinal direction of the concave stepped portions 1116.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in across-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 10-4

As an example of the present invention, an LC display apparatus was produced in the same manner as in Example 10-1, except that a concave stepped portion 1216 was formed along a side edge of each ITO pixel in the manner shown in FIGS. 12A and 12B by a laser half-cut technique, instead of forming a protrusion of photosensitive resin BPR107 (Japan Synthetic Rubber Co., Ltd.). The rubbing direction was perpendicular to the longitudinal direction of the concave stepped portions 1216.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially Aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e. a without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight, gray scale levels with respect to eight variations of transmitted light amounts (8×8=64 states) were also confirmed to be all equal to or less than 2.5 ms, indicative of a very fast response.

### EXAMPLE 10-5

As an example of the present invention, an LC display apparatus was produced as follows. TFT elements were formed on a glass substrate. A transparent electrode film of ITO (thickness: 1000 Å) was formed so as to be in contact with the glass substrate, thereby forming a matrix electrode substrate. The ITO film was patterned into pixel electrodes sized 300 μm×300 μm each. A transparent electrode film of ITO (thickness: 1000 Å) was formed on another glass substrate to form a counter substrate.

A vertical alignment film JALS-955 (Japan Synthetic Rubber Co., Ltd.) was formed on the side of each substrate on which the electrode(s) was(were) formed. Ultraviolet rays (wavelength: 270 nm) were irradiated through a photomask for shielding the pixel portions only. A rubbing treatment was applied to both substrates in parallel directions to each other. The two substrates were attached to each other to obtain a cell thickness of 3 μm. Nematic liquid crystal MJ95955 (Merck & Co., Inc.) was injected into the cell, whereby an LC cell was completed. This LC material has a dielectric anisotropy of −3.3.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the Lc by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 10-6

As an example of the present invention, an LC display apparatus was produced as follows. TFT elements were formed on a glass substrate. By providing pairs of opposing comb electrodes 1403 as shown in FIGS. 14A and 14B thereon, a matrix electrode substrate was formed with which it is possible to apply an electric field in a direction parallel to the substrate surfaces. The pixel electrodes were each sized to be 100 μm×100 μm. Another glass substrate was used to form a counter substrate.

A vertical alignment film JALS-955 (Japan Synthetic Rubber Co., Ltd.) was formed on the side of each substrate on which the electrode(s) was(were) formed. Ultraviolet rays (wavelength: 270 nm) were irradiated through a photomask for shielding the pixel portions only. A rubbing treatment was applied to both substrates in parallel directions to each other. The rubbing direction was perpendicular to a direction in which each pair of comb electrodes opposed each other to define pixels. The two substrates were attached to each other to obtain a cell thickness of 3 μm. Nematic liquid crystal E7 (Merck & Co., Inc.) was injected into the cell, whereby an LC cell was completed. This LC material has a dielectric anisotropy of 13.8.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 11-1

As an example of the present invention, an LC display apparatus was produced as follows, TFT elements were formed on a glass substrate. A transparent electrode film of ITO (thickness: 1000 Å) was formed so as to be in contact with the glass substrate, thereby forming a matrix electrode substrate. The ITO film was patterned into pixel electrodes sized 300 μm×300 μm each. A piece of photosensitive resin BPR107 (Japan Synthetic Rubber Co., Ltd.), having a width of 10 μm and a thickness of 1 μm, was formed as a protrusion in the central portion of each ITO pixel in the manner shown in FIGS. 8A and 8B. A transparent electrode film of ITO (thickness: 1000 Å) was formed on another glass substrate to form a counter substrate.

A vertical alignment film JALS-955 (Japan Synthetic Rubber Co., Ltd.) was formed on the side of each substrate on which the electrode(s) was(were) formed. Linearly polarized ultraviolet rays (wavelength: 270 nm) were irradiated through a photomask for shielding the pixel portions only. The direction of linear polarization was perpendicular to the longitudinal direction of the protrusions. The two substrates were attached to each other to obtain a cell thickness of 3 μm. Nematic liquid crystal MJ95955 (Merck & Co., Inc.) was injected into the cell, whereby an LC cell was completed. This LC material has.a dielectric anisotropy of −3.3.

The resultant LC cell was interposed between a pair of polarization plates placed in a cross-nicol arrangement and operated so as to be observed in the absence of an applied voltage. A very excellent dark display state was observed when the direction of linear polarization of the irradiated ultraviolet rays coincided with either axis of polarization of the polarization plates. As the cell was rotated, transmitted light began to be observed in the non-pixel portions, and the amount of transmitted light became maximum with a rotation angle of 45°. Thus, it was confirmed that a horizontal alignment which was uniaxially aligned in the direction of linear polarization of the irradiated ultraviolet rays had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the direction of linear polarization of the irradiated ultraviolet rays coincided with either axis of polarization of the polarization plates. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the direction of linear polarization of the irradiated ultraviolet rays was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) Were also confirmed to be all equal to or less than 2.5 ms, indicative of a very fast response,

### EXAMPLE 11-2

As an example of the present invention, an LC display apparatus was produced in the same manner as in Example 11-1, except that a piece of photosensitive resin BPR107 (Japan Synthetic Rubber Co., Ltd.) was formed as a protrusion 1015 along a side edge of each ITO pixel (i.e. electrode 1003) in the manner shown in FIGS. 10A and The resultant LC cell was interposed between a pair of polarization plates placed in a cross-nicol arrangement and operated so as to be observed in the absence of an applied voltage. A very excellent dark display state was observed when the direction of linear polarization of the irradiated ultraviolet rays coincided with either axis of polarization of the polarization plates. As the cell was rotated, transmitted light began to be observed in the non-pixel portions, and the amount of transmitted light became maximum with a rotation angle of 45°. Thus, it was confirmed that a horizontal alignment which was uniaxially aligned in the direction of linear polarization of the irradiated ultraviolet rays had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the direction of linear polarization of the irradiated ultraviolet rays coincided with either axis of polarization of the polarization plates. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the direction of linear polarization of the irradiated ultraviolet rays was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 11-3

As an example of the present invention, an LC display apparatus was produced in the same manner as in Example 11-1, except that a concave stepped portion 1116 was formed in the central portion of each ITO pixel (i e., electrode 1103) in the manner shown in FIGS. 11A and 11B by a laser half-cut technique, instead of forming a protrusion of photosensitive resin BPR107 (Japan Synthetic Rubber Co., Ltd.). The direction of linear polarization of the irradiated ultraviolet rays was perpendicular to the longitudinal direction of the concave stepped portions 1116.

The resultant LC cell was interposed between a pair of polarization plates placed in a cross-nicol arrangement and operated so as to be observed in the absence of an applied voltage. A very excellent dark display state was observed when the direction of linear polarization of the irradiated ultraviolet rays coincided with either axis of polarization of the polarization plates. As the cell was rotated, transmitted light began to be observed in the non-pixel portions, and the amount of transmitted light became maximum with a rotation angle of 45°. Thus, it was confirmed that a horizontal alignment which was uniaxially aligned in the direction of linear polarization of the irradiated ultraviolet rays had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the direction of linear polarization of the irradiated ultraviolet rays coincided with either axis of polarization of the polarization plates. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the direction of linear polarization of the irradiated ultraviolet rays was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 11-4

As an example of the present invention, an LC display apparatus was produced in the same manner as in Example 11-1, except that a concave stepped portion 1216 was formed along a side edge of each ITO pixel in the manner shown in FIGS. 12A and 12B by a laser half-cut technique, instead of forming a protrusion of photosensitive resin BPR107 (Japan Synthetic Rubber Co., Ltd.). The direction of linear polarization of the irradiated ultraviolet rays was perpendicular to the longitudinal direction of the concave stepped portions 1216.

The resultant LC cell was interposed between a pair of polarization plates placed in a cross-nicol arrangement and operated so as to be observed in the absence of an applied voltage. A very excellent dark display state was observed when the direction of linear polarization of the irradiated ultraviolet rays coincided with either axis of polarization of the polarization plates. As the cell was rotated, transmitted light began to be observed in the non-pixel portions, and the amount of transmitted light became maximum with a rotation angle of 45°. Thus, it was confirmed that a horizontal alignment which was uniaxially aligned in the direction of linear polarization of the irradiated ultraviolet rays had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the direction of linear polarization of the irradiated ultraviolet rays coincided with either axis of polarization of the polarization plates. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the direction of linear polarization of the irradiated ultraviolet rays was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 11-5

As an example of the present invention, an LC display apparatus was produced as follows. TFT elements were formed on a glass substrate. A transparent electrode film of ITO (thickness: 10000 Å) was formed so as to be in contact with the glass substrate, thereby forming a matrix electrode substrate. The ITO film was patterned into pixel electrodes sized 300 μm×300 μm each. A transparent electrode film of ITO (thickness: 100 Å) was formed on another glass substrate to form a counter substrate.

A vertical alignment film JALS-955 (Japan Synthetic Rubber Co. Ltd.) was formed on the side of each substrate on which the electrodes) was(were) formed, Linearly polarized ultraviolet rays (wavelengths 270 nm) were irradiated through a photomask for shielding the pixel portions only. A rubbing treatment was applied to both substrates in parallel directions to each other. The two substrates were attached to each other to obtain a cell thickness of 3 μm. The rubbing direction was parallel to the polarization direction of the ultraviolet rays. Nematic liquid crystal MJ95955 (Merck & Co., Inc.) was injected into the cell, whereby an LC cell was completed. This LC material has a dielectric anisotropy of −3.3.

The resultant LC cell was interposed between a pair of polarization plates placed in a cross-nicol arrangement and operated so as to be observed in the absence of an applied voltage. A very excellent dark display state was observed when the rubbing direction coincided with either axis of polarization. As the cell Was rotated, transmitted light began to be observed in the non-pixel portions, and the amount of transmitted light became maximum with a rotation angle of 45°. Thus, it was confirmed that a horizontal alignment which was uniaxially aligned in the rubbing direction had been obtained. On the other hand, the pixel portions always exhibited an excellent dark display state, indicative of a vertical alignment. The amount of transmitted light was measured using a backlight (10000 cd/m²) while placing the LC display apparatus in an arrangement where the rubbing direction coincided with either axis of polarization. As a result, the transmitted light through the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the rubbing direction was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

### EXAMPLE 11-6

As an example of the present invention, an LC display apparatus was produced as follows. TFT elements were formed on a glass substrate. By providing pairs of opposing comb electrodes 1403 as shown in FIGS. 14A and 14B thereon, a matrix electrode substrate was formed with which it is possible to apply an electria field in a direction parallel to the substrate surfaces. The pixel electrodes were each sized to be 100 μm×100 μm. Another glass substrate was used to form a counter substrate.

A vertical alignment film JALS-955 (Japan Synthetic Rubber Co., Ltd.) was formed on the side of each substrate on which the electrode(s) was(were) formed. Linearly polarized ultraviolet rays (wavelength: 270 nm) were irradiated through a photomask for shielding the pixel portions only. The direction of linear polarization of the irradiated ultraviolet rays was perpendicular to a direction in which each pair of comb electrodes opposed each other to define pixels. The two substrates were attached to each other to obtain a cell thickness of 3 μm. Nematic liquid crystal E7 (Merck & Co., Inc.) was injected into the cell, whereby an LC cell was completed. This LC material has a dielectric anisotropy of 13.8.

The resultant LC cell was interposed between a pair of polarization plates placed in a cross-nicol arrangement and operated so as to be observed in the absence of an applied voltage. A very excellent dark display state was observed when the direction of linear polarization of the irradiated ultraviolet rays coincided with either axis of polarization of the polarization plates. As the cell was rotated, transmitted light began to be observed in the non-pixel portions, and the amount of transmitted light became maximum with a rotation angle of 45°. Thus, it was confirmed that a horizontal alignment which was uniaxially aligned in the direction of linear polarization of the irradiated ultraviolet rays had been obtained. On the other hand, the pixel portions always exhibited an excellent dark display state, indicative of a vertical alignment. The amount of transmitted light was measured Using a backlight (10000 cd/m² while placing the LC display apparatus in an arrangement where the direction of linear polarization of the irradiated ultraviolet rays coincided with either axis of polarization of the polarization plates. As a result, the transmitted light through, the LC cell interposed between the pair of polarization plates in a cross-nicol arrangement was 2.3 cd/m². For comparison, the transmitted light through only the pair of polarization plates in a cross-nicol arrangement (i.e., without the LC cell) was 2.1 cd/m². Thus, there was substantially no change in the transmitted light amount.

Next, a rectangular wave electric field (120 Hz) was applied while placing the LC display apparatus in an arrangement where the direction of linear polarization of the irradiated ultraviolet rays was at an angle of 45° with either polarization axis. As a result, the pixel portions began to brighten up in the neighborhood of 1.5 V. As the applied voltage was increased, the amount of transmitted light increased, until reaching 1900 cd/m² at 5 V. Thus, a contrast of 800 or more was obtained. An observation with a microscope revealed total absence of disclination, which would always be observed in a conventional VA mode, even at boundaries between the pixel and the non-pixel portions.

As a result of measuring the response time of the LC by using a photodiode and an oscilloscope, the LC cell was confirmed to have a rising time of 1 ms and a falling time of 0.8 ms, indicative of a significantly faster response than that attained by a conventional VA mode. The response times for eight gray scale levels with respect to eight variations of transmitted light amounts (8×8=64 states) were also confirmed to be all equal to or less than 2.5 ms, indicative of a very fast response.

As described above, according to the present invention, it is ensured that LC molecules will tilt in asymmetrical directions in a VA mode in which optical changes take place responsive to the application of an electric field for causing an LC material in pixel portions which is originally oriented in a vertical alignment to be realigned in a horizontal alignment, the LC material having a negative dielectric anisotropy. As a result, disclination is prevented from occurring. Thus, a significantly enhanced contrast and a significantly enhanced response speed can be obtained as compared to those obtained in accordance with conventional LC apparatuses. Consequently, high-quality display images are provided such that moving pictures can be displayed without blurring.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A liquid crystal display apparatus comprising:
a pair of substrates opposing each other;
a liquid crystal layer interposed between the pair of substrates, the liquid crystal layer containing liquid crystal molecules having a negative dielectric anisotropy;
at least one electrode provided on each of the pair of substrates, the at least one electrode being used for applying an electric field across the liquid crystal layer; and
at least one volume excluding member,
wherein: one of the at least one volume excluding member is provided on the at least one electrode on at least one of the pair of substrates, the volume excluding member being provided so as to be on at least a portion of one side edge of the at least one electrode;
a side of each of the pair of substrates facing the liquid crystal layer is subjected to a vertical alignment treatment; and
the liquid crystal molecules are tilted in a uniform direction from the at least one side edge of the at least one electrode to an opposite edge when a voltage is applied to the at least one electrode.

2. A liquid crystal display apparatus according to claim 1, wherein the volume excluding member comprises at least one of a protrusion and a concave stepped portion.

3. A liquid crystal display apparatus according to claim 1, wherein the volume excluding member is provided along the entirety of the at least one side edge of the at least one electrode.

4. A liquid crystal display apparatus comprising:
a pair of substrates opposing each other;
a liquid crystal layer interposed between the pair of substrates, the liquid crystal layer containing liquid crystal molecules having a negative dielectric anisotropy;
at least one electrode provided on each of the pair of substrates, the at least one electrode being used for applying an electric field across the liquid crystal layer; and
a plurality of volume excluding members provided on the at least one electrode on at least one of the pair of substrates, each of the plurality of volume excluding members being provided so as to be on at least a portion of each of an opposing pair of side edges of the at least one electrode but so as not to oppose each other,
wherein:
a side of each of the pair of substrates facing the liquid crystal layer is subjected to a vertical alignment treatment; and
the liquid crystal molecules are tilted in a uniform direction from the at least one side edge of the at least one electrode to an opposite edge when a voltage is applied to the at least one electrode.

5. A liquid crystal display apparatus according to claim 4, wherein:
the at least one electrode on the at least one of the pair of substrates includes a first side edge and a second side edge; and
the plurality of volume excluding members are provided along a portion of the first side edge and along a portion of the second side edge.

6. A liquid crystal display apparatus according to claim 4, wherein a non-conductive window portion is formed in the at least one electrode on the at least one of the pair of substrates.

7. A liquid crystal display apparatus comprising:
a pair of substrates opposing each other;
a liquid crystal layer interposed between the pair of substrates, the liquid crystal layer containing liquid crystal molecules; and
at least one electrode provided on at least one of the pair of substrates, the at least one electrode being used for applying an electric field across the liquid crystal layer,
wherein:
the liquid crystal layer includes at least one pixel portion and a non-pixel portion, the at least one pixel portion corresponding to the at least one electrode; and
when voltage is not applied to the at least one electrode, the liquid crystal molecules in the at least one pixel portion are oriented in a vertical alignment and the liquid crystal molecules in the non-pixel portion are oriented in a uniaxial horizontal alignment.

8. A liquid crystal display apparatus according to claim 7, wherein the liquid crystal molecules in the at least one pixel portion are oriented in a horizontal alignment so as to be tilted in a uniform direction when a voltage is applied to the at least one electrode.

9. A liquid crystal display apparatus according to claim 8, wherein a volume excluding member is formed on a portion of the at least one electrode.

10. A liquid crystal display apparatus according to claim 9, wherein the volume excluding member comprises at least one of a protrusion and a concave stepped portion.

11. A liquid crystal display apparatus according to claim 8, wherein a side of the at least one of the pair of substrates facing the liquid crystal layer is subjected to a rubbing treatment.

12. A liquid crystal display apparatus according to claim 8, wherein the at least one electrode comprises a comb electrode.

13. A liquid crystal display apparatus according to claim 7,
wherein the liquid crystal molecules in the non-pixel portion are oriented in a uniaxial horizontal alignment by at least one method selected from the group consisting of: subjecting a horizontal alignment film to a rubbing treatment; subjecting a vertical alignment film to a selective chemical modification treatment followed by a rubbing treatment; subjecting a vertical alignment film to a selective irradiation of ultraviolet rays followed by a rubbing treatment; and subjecting a vertical alignment film to an irradiation of selectively polarized ultraviolet rays.

14. A liquid crystal display apparatus according to claim 8, wherein a direction of the horizontal alignment of the liquid crystal molecules in the at least one pixel portion is substantially identical to a direction of uniaxial horizontal alignment of the liquid crystal molecules in the non-pixel portion.
